(19) United States
(12) Patent Application Publication
(10) Pub. No.: US 2026/0277595 A1
(43) Pub. Date: Sep. 17, 2026

(54) HOT UPDATE DETECTION METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Shaojie SUN, Shenzhen (CN); Yang YU, Shenzhen (CN); Lidong ZHAI, Shenzhen (CN)

(21) Appl. No.: 19/670,410

(22) Filed: May 7, 2026

Related U.S. Application Data
(63) Continuation of application No. PCT/CN2025/078711, filed on Feb. 24, 2025.

(30) Foreign Application Priority Data
Mar. 1, 2024 (CN) 202410235159.5

(51) Int. Cl. G06F 8/656

(52) U.S. Cl. CPC G06F 8/656

(57) ABSTRACT

A hot update detection method includes: determining a machine executable instruction currently being executed for an application; determining a current execution function, and determining, when the current execution function is of a preset candidate function type for detection, data passed to the current execution function; determining a tag storage location of the passed data, in a process of executing a series of execution functions based on original data of the application, a tag storage location of data generated based on any execution function being configured for recording a data source tag for data passed to the any execution function; and determining, when a data source tag is obtained from the tag storage location of the passed data, that the application undergoes a hot update, the obtained data source tag being configured for indicating that the passed data originates locally or from a network other than an original installation package.

### CROSS-REFERENCES TO RELATED APPLICATIONS

This application is a continuation application of PCT Patent Application No. PCT/CN2025/078711, filed on Feb. 24, 2025, which claims priority to Chinese Patent Application No. 2024102351595, filed on Mar. 1, 2024, all of which is incorporated herein by reference in their entirety.

### FIELD OF THE TECHNOLOGY

The present disclosure relates to the field of computer technologies, and in particular, to a hot update detection method and apparatus, a computer device, and a storage medium.

### BACKGROUND OF THE DISCLOSURE

With the development of science and technology, hot update technology has emerged. Hot update, also referred to as hot fix, is a technology that allows software or applications to be updated or fixed online without shutdown or restart the system. Currently, due to strong concealment, the hot update technology is often used by an unauthorized developer for technical evasion, to bypass compliance management. Therefore, it is necessary to inspect applications to determine whether hot update behavior occurs in running process of the applications.

Currently, the main approach is to analyze an installation package file of an application without running the application, and determine from analysis results whether a hot update occurs in the running process of the application. This process involves scanning the code and resource files in the installation package file, for example, checking whether the installation package includes a class name, a method call, or a specific resource file of a known hot update framework.

However, manual analysis of the installation package files is a time-consuming process, which leads to low efficiency in detecting hot updates.

### SUMMARY

One embodiment of the present disclosure provides a hot update detection method, performed by a computer device. The method includes: determining, in a running process of an application, a machine executable instruction currently being executed for the application; determining a current execution function executed based on the machine executable instruction, and determining, when the current execution function is of a preset candidate function type for detection, data passed to the current execution function; determining a tag storage location of the passed data, in a process of executing a series of execution functions based on original data of the application, a tag storage location of data generated based on any execution function being configured for recording a data source tag for data passed to the any execution function; and determining, when a data source tag is obtained from the tag storage location of the passed data, that the application undergoes a hot update, the obtained data source tag being configured for indicating that the passed data originates locally or from a network other than an original installation package.

Another embodiment of the present disclosure provides a computer device comprising one or more processors and a memory containing computer readable instructions that, when being executed, cause the one or more processors to perform: determining, in a running process of an application, a machine executable instruction currently being executed for the application; determining a current execution function executed based on the machine executable instruction, and determining, when the current execution function is of a preset candidate function type for detection, data passed to the current execution function; determining a tag storage location of the passed data, in a process of executing a series of execution functions based on original data of the application, a tag storage location of data generated based on any execution function being configured for recording a data source tag for data passed to the any execution function; and determining, when a data source tag is obtained from the tag storage location of the passed data, that the application undergoes a hot update, the obtained data source tag being configured for indicating that the passed data originates locally or from a network other than an original installation package.

Another embodiment of the present disclosure provides a non-transitory computer readable storage medium containing computer readable instructions that, when being executed, cause at least one processor to perform: determining, in a running process of an application, a machine executable instruction currently being executed for the application; determining a current execution function executed based on the machine executable instruction, and determining, when the current execution function is of a preset candidate function type for detection, data passed to the current execution function; determining a tag storage location of the passed data, in a process of executing a series of execution functions based on original data of the application, a tag storage location of data generated based on any execution function being configured for recording a data source tag for data passed to the any execution function; and determining, when a data source tag is obtained from the tag storage location of the passed data, that the application undergoes a hot update, the obtained data source tag being configured for indicating that the passed data originates locally or from a network other than an original installation package.

Details of one or more embodiments of the present disclosure are provided in the following accompanying drawings and descriptions. Other features, objectives, and advantages of the present disclosure become apparent from the specification, the drawings, and the claims.

### BRIEF DESCRIPTION OF THE DRAWINGS

To describe technical solutions in the embodiments of the present disclosure more clearly, the following briefly describes the accompanying drawings for describing the embodiments. Apparently, the accompanying drawings in the following descriptions show merely embodiments of the present disclosure, and a person of ordinary skill in the art may still derive other drawings from disclosed accompanying drawings without creative efforts.

FIG. 1 is a diagram of an application environment of a hot update detection method according to an embodiment of the present disclosure.

FIG. 2 is a schematic flowchart of a hot update detection method according to an embodiment of the present disclosure.

FIG. 3 is a schematic diagram of application icons according to an embodiment of the present disclosure.

FIG. 4 is a schematic diagram of a splash screen of an application according to an embodiment of the present disclosure.

FIG. 5 is a schematic diagram of extraction of a data source tag according to an embodiment of the present disclosure.

FIG. 6 is a schematic diagram of a virtual machine stack according to an embodiment of the present disclosure.

FIG. 7 is a schematic diagram of data tag passing according to an embodiment of the present disclosure.

FIG. 8 is a schematic overall flowchart of a hot update detection method according to an embodiment of the present disclosure.

FIG. 9 is a schematic diagram of a task center according to an embodiment of the present disclosure.

FIG. 10 is a schematic diagram of a task center according to another embodiment of the present disclosure.

FIG. 11 is a schematic diagram of a detection page of a detection platform according to an embodiment of the present disclosure.

FIG. 12 is a schematic diagram of a task center according to another embodiment of the present disclosure.

FIG. 13 is a schematic overall flowchart of a hot update detection method according to another embodiment of the present disclosure.

FIG. 14 is a schematic interaction diagram of a hot update detection method according to an embodiment of the present disclosure.

FIG. 15 is a schematic flowchart of a hot update detection method according to a specific embodiment of the present disclosure.

FIG. 16 is a schematic overall block diagram of a hot update detection method according to an embodiment of the present disclosure.

FIG. 17 is a block diagram of a structure of a hot update detection apparatus according to an embodiment of the present disclosure.

FIG. 18 is a diagram of an internal structure of a computer device according to an embodiment of the present disclosure.

FIG. 19 is a diagram of an internal structure of a computer device according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings and the embodiments. The specific embodiments described herein are merely used for explaining the present disclosure, but are not intended to limit the present disclosure.

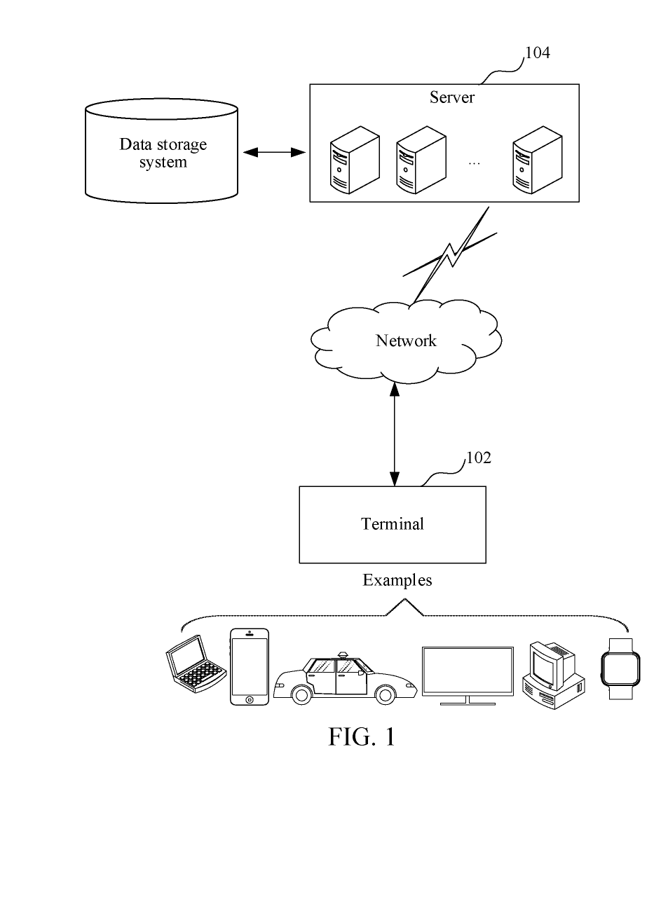

A hot update detection method provided in the embodiments of the present disclosure may be applied to an application environment shown in FIG. 1. A terminal 102 communicates with a server 104 via a network. A data storage system may store data that needs to be processed by the terminal 102. The data storage system may be integrated on the server 104, or may also be placed on a cloud or another server. A detection platform and a virtual terminal may run in the terminal 102, and the server 104 may be a back-end server of the detection platform. A user may upload an installation package of an application through the detection platform, so that the detection platform may trigger the virtual terminal to install the installation package, to obtain the application running in the virtual terminal. The virtual terminal may display an application interface of the application. After the user taps a start detection control on the detection platform, a hot update behavior of the application may be detected in a running process of the application. The terminal 102 may be, but not limited to, a desktop computer, a notebook computer, a tablet computer, an internet of things device, or a portable wearable device. The internet of things device may be a smart speaker, a smart television, a smart air conditioner, a smart in-vehicle device, or the like. The portable wearable device may be a smart watch, a smart band, a head-mounted device, and the like. The server 104 may further be implemented by using an independent server or a server cluster including a plurality of servers.

The "first", the "second", and similar terms used in the present disclosure do not indicate any order, quantity, or significance, but are used to only distinguish different components. Unless the context clearly indicates otherwise, singular forms, such as "a", "an", or "the", do not indicate a quantity limitation, but indicate the presence of at least one. A quantity indicated by "a plurality of", "multiple", or the like mentioned in the embodiments of the present disclosure means a quantity of "at least two". For example, "a plurality of" means "at least two", and "multiple" also means "at least two".

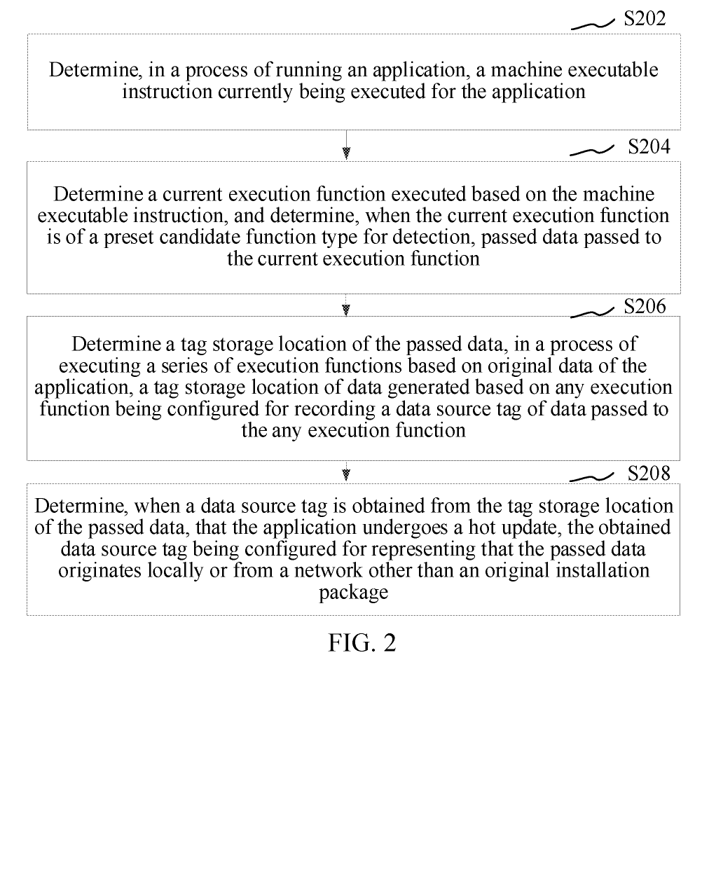

In an embodiment, as shown in FIG. 2, a hot update detection method is provided. An example in which the method is applied to the terminal in FIG. 1 is used for description. The method includes the following operations.

Operation 202: Determine, in a running process of an application, a machine executable instruction currently being executed for the application.

The machine executable instruction for the application is an instruction that is obtained by compiling code of the application and that is recognizable by a machine. The machine executable instruction currently being executed is a machine executable instruction executed at a current moment.

The application may run in a virtual terminal. The virtual terminal is a virtual terminal device. For example, the virtual terminal may be a virtual Android device, and the Android device can simulate hardware and software environments of a real Android device on a server. The virtual Android device may be specifically a cloud phone. An operating system of the virtual terminal is a customized Android system. The customized Android system includes a virtual machine for executing the machine executable instruction, and further includes a data flow determining system, a behavior recording program, and a detection system. The data flow determining system is configured to capture and record all data flows in the running process of the application. The behavior recording program is configured to record a behavior of the application, for example, record a local data access behavior of the application. The detection system is configured to analyze a source of data passed to a corresponding function.

Specifically, the detection platform is a platform configured to detect the application. For example, a hot update behavior of the application may be detected through the detection platform. When a user expects to detect the application through the detection platform, the user may upload an installation package of the application to the detection platform, so that the detection platform may start a virtual terminal, and cause the virtual terminal to install the application by using the installation package. Further, when the user determines to start detecting the application, the user may start the application through an application icon displayed in the virtual terminal and use the application, for example, navigating different interfaces of the application or inputting data. The virtual machine in the customized Android system executes each machine executable instruction, so that the application can run normally. The data flow determining system is built in the virtual machine, and may perform synchronous interception when the virtual machine executes the machine executable instruction, to determine the machine executable instruction currently being executed.

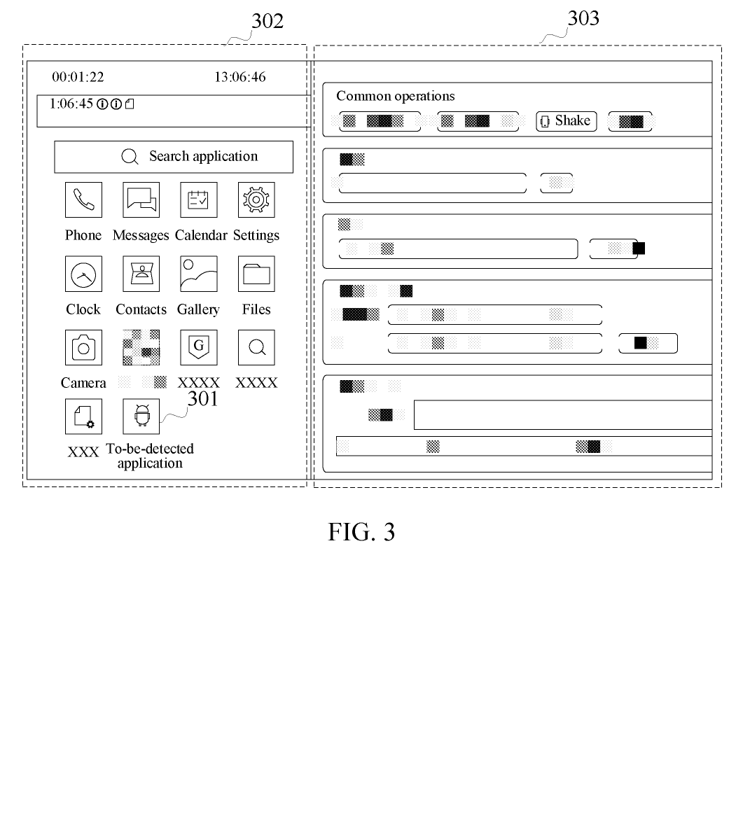

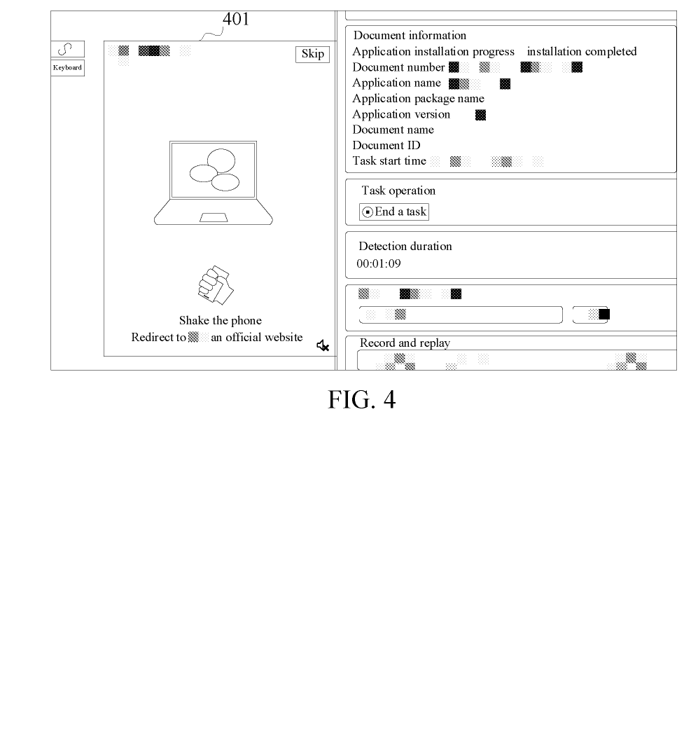

In an embodiment, after the application is installed in the virtual terminal, the detection platform may display a terminal interface of the virtual terminal, and display the application icon of the application through the terminal interface, for example, an application icon 301 shown in FIG. 3. When the user taps the application icon, the virtual terminal may start the application and display an application interface of the application, for example, a splash screen 401 of an application shown in FIG. 4. FIG. 3 is a schematic diagram of application icons according to an embodiment. In FIG. 3, 302 denotes the terminal interface of the virtual terminal, and 303 denotes a detection page of the detection platform. FIG. 4 is a schematic diagram of the splash screen according to an embodiment.

Operation 204: Determine a current execution function executed based on the machine executable instruction, and determine, when the current execution function is of a preset candidate function type for detection, passed data passed to the current execution function.

Specifically, after the data flow determining system determines the machine executable instruction currently being executed, the detection system may analyze the machine executable instruction currently being executed, to determine a function that is executed based on the machine executable instruction currently being executed. For ease of description, the function that is executed based on the machine executable instruction currently being executed is referred to as the current execution function below. For example, when the machine executable instruction currently being executed is an instruction instructing to copy data A, it is determined that the current execution function executed based on the machine executable instruction is a data copy function. Further, the detection system may determine whether the current execution function is of the preset candidate function type for detection. If the current execution function is of the preset candidate function type for detection, the detection system may determine data passed to the current execution function, that is, input data of the current execution function. For ease of description, the data passed to the current execution function is referred to as passed data below.

In an embodiment, the detection system may obtain a function of the preset candidate function type for detection, to obtain a third function set. The detection system checks whether the current execution function is included in the third function set. If the current execution function is included, the detection system determines that the current execution function is of the preset candidate function type for detection. If the current execution function is not included, the detection system determines that the current execution function is not of the preset candidate function type for detection.

In an embodiment, the preset candidate function type for detection may be specifically a sink function type. A function of the sink function type is a function that may output data to a sensitive destination (for example, class loading or dynamic library loading). The function of the sink function type may be specifically a library loading function, a class loading function, or the like. In the present disclosure, the hot update behavior of the application needs to be detected, and in a hot update process, a class loader may be used to dynamically load a class or a dynamic library. Therefore, the hot update behavior of the application may be determined by determining whether the current execution function is a class loading function or a library loading function.

In an embodiment, after the current execution function is determined, the passed data passed to the current execution function may be determined based on a keyword in the current execution function. For example, the passed data passed to the current execution function may be positioned based on a keyword "input" in the current execution function.

Operation 206: Determine a tag storage location of the passed data, in a process of executing a series of execution functions based on original data of the application, a tag storage location of data generated based on any execution function being configured for recording a data source tag of data passed to the any execution function.

Specifically, the detection system may determine, based on a data type of the passed data, a location for storing a data source tag of the passed data. For ease of description, the determined location for storing the data source tag of the passed data is referred to as the tag storage location below. For example, a correspondence between different data types and storage locations is preset in the detection system. When the data type of the passed data is determined, the tag storage location of the passed data may be determined based on the correspondence.

In an embodiment, determining the tag storage location of the passed data includes: determining, when the passed data is of a data object type, that the tag storage location of the passed data is an extended structure of the passed data; and determining, when the passed data is of a non-data object type, that the tag storage location of the passed data is a virtual machine stack storing the passed data.

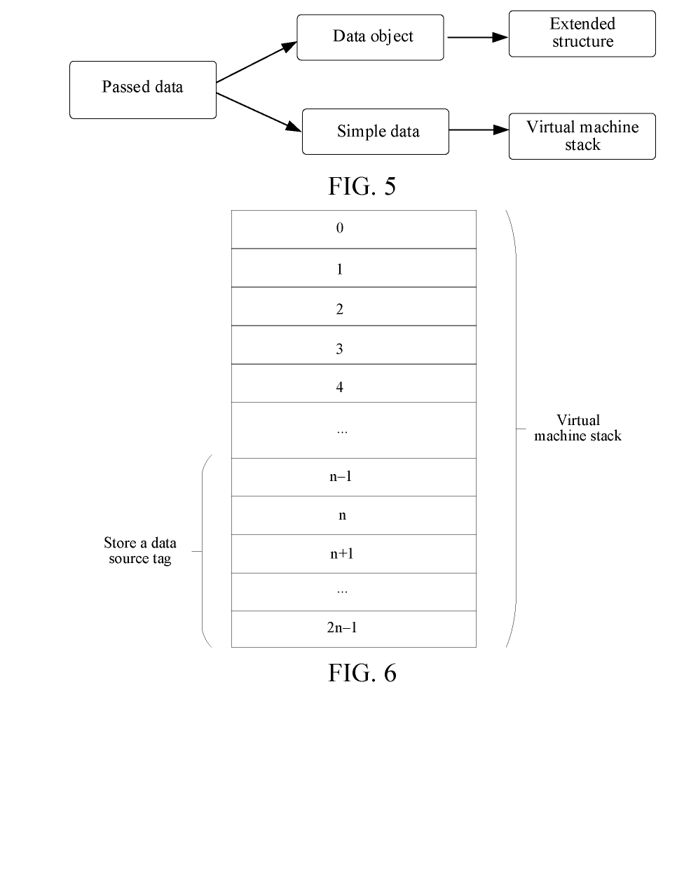

Specifically, the detection system may determine the data type of the passed data and determine the tag storage location of the passed data based on the data type. For example, referring to FIG. 5. When the passed data is a data object, that is, when the passed data is of an object type, it is determined that the data source tag is to be obtained from the extended structure of the passed data. When the passed data is simple data and is not a data object, it is determined that the data source tag is to be obtained from the virtual machine stack in which the passed data is located. The data source tag is an identifier for tagging a data source. For example, the data source tag may be "network" or "local". When a data source tag is "network", it is determined that data tagged by the data source tag originates from a network. When a data source tag is "local", it is determined that data tagged by the data source tag originates locally. FIG. 5 is a schematic diagram of extraction of a data source tag according to an embodiment.

In an embodiment, any entity that can be defined by a group of attributes may be considered as a data object. The data object may be an instance of a class, and has its own attribute and method. In Java, a data object is usually an instance created by using a keyword new. An extended structure of the data object may be specifically a set of fields of the data object, or a set of attributes of the data object. The detection system may determine whether the passed data is a data object by determining whether the passed data is created by using a preset keyword. For example, when the passed data is created by using the keyword new, it may be determined that the passed data is a data object. For another example, the detection system may determine whether the passed data has an attribute and a method. If the passed data has the attribute and the method, it is determined that the passed data is a data object.

In an embodiment, the virtual machine stack is a stack-like storage space, the virtual machine stack is private to a thread, and a life cycle of the virtual machine stack is the same as that of the thread. A virtual machine stack is created each time a thread is created, and the stack internally stores stack frames corresponding to successive method calls. When determining that the tag storage location is the virtual machine stack, the detection system may further determine a stack frame of the virtual machine stack from which the data source tag is to be extracted. For example, the detection system may determine a location of the passed data in the virtual machine stack, and based on the location of the passed data in the virtual machine stack, determine a specific tag storage location.

In embodiments of the present disclosure, the virtual machine stack is a stack whose size is twice a normal size. In a typical solution, when a size of a virtual machine stack is n, the size of the virtual machine stack in embodiments of the present disclosure is 2n. Referring to FIG. 6. A 0^{th} stack frame to an (n–1)^{th} stack frame are configured for storing data in a typical manner, and an n^{th} stack frame to a (2n–1)^{th} stack frame are configured for storing a data source tag. The data stored in the 0^{th} stack frame to the (n–1)^{th} stack frame are in one-to-one correspondence with the data source tag stored in the n^{th} stack frame to the (2n–1)^{th} stack frame. For example, when data is stored in the 0^{th} stack frame, a data source tag corresponding to the data is stored in the (n–1)^{th} stack frame; when data is stored in a 1^{st} stack frame, a data source tag corresponding to the data is stored in the n^{th} stack frame; and so on. FIG. 6 is a schematic diagram of a virtual machine stack according to an embodiment.

Therefore, when a stack frame storing the passed data is determined, a stack frame storing the data source tag of the passed data may be determined based on the stack frame storing the passed data. For example, the detection system stores a correspondence between stack frames for storing data and stack frames for storing data source tags. When the stack frame storing the passed data is determined, the detection system may determine, based on the correspondence, the stack frame storing the data source tag of the passed data. The stack frame storing the data source tag of the passed data is a specific tag storage location. For another example, when the stack frame storing the passed data is determined, a distance between the stack frame storing the passed data and a stack top may be determined, a middle portion of the virtual machine stack is used as a reference, and the stack frame storing the data source tag of the passed data is determined based on the distance.

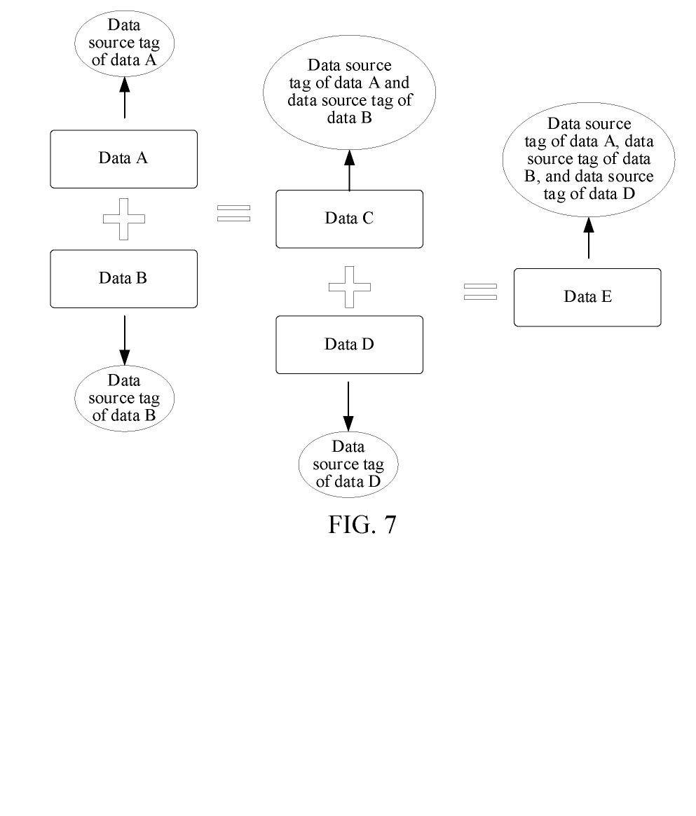

In an embodiment, in the process of executing a series of execution functions based on the original data of the application, the tag storage location of the data generated based on any execution function is configured for recording the data source tag of the data passed to the any execution function. For example, referring to FIG. 7. In the running process of the application, after the original data is obtained, the original data may undergo a series of processing, and the tag storage location stores a data source tag of data involved in a series of processing. For example, when the passed data is data E, and the original data is data A, if data A and data B are combined to obtain data C, and data C and data D are further combined to obtain data E, a data source tag of data A and a data source tag of data B are stored at a tag storage location of data C, and a data source tag of data C and a data source tag of data D are stored at a tag storage location of data E. In addition, because the data source tag of data A and the data source tag of data B are stored at the tag storage location of data C, it may be considered that the data source tag of data C includes the data source tag of data A and the data source tag of data B. Therefore, the data source tag of data A, the data source tag of data B, and the data source tag of data D are actually stored at the tag storage location of data E. In this example, data A may be considered as the original data, data E may be considered as the passed data input into the current execution function, and data E may be considered as being generated and obtained based on data A. In this case, the data source tag of data A is passed to data E, and is stored at the tag storage location of data E. FIG. 7 is a schematic diagram of data tag passing according to an embodiment. In an embodiment, the data source tag may be used as metadata of the passed data, and is passed together with the passed data, without affecting normal functions of the application.

In the foregoing embodiments, when a type of data is determined, a tag storage location can be accurately determined based on the type, and an accurate data source tag is obtained from the accurately determined tag storage location.

Operation 208: Determine, when the data source tag is obtained from the tag storage location of the passed data, that the application undergoes a hot update, the obtained data source tag being configured for indicating that the passed data originates locally or from a network other than an original installation package.

Specifically, after determining the passed data and the tag storage location of the passed data, the detection system may determine whether the data source tag can be extracted from the tag storage location of the passed data, and if it is determined that the data source tag can be obtained from the tag storage location of the passed data, determine that the application undergoes the hot update.

Only data obtained from the network or locally has a data source tag, or data generated based on the data obtained from the network or locally has a data source tag. Therefore, when a data source tag is obtained from the tag storage location of the passed data, it may be determined that the passed data has the data source tag. When the passed data has the data source tag, it is considered that the passed data is obtained from the network or locally, or it may be considered that the original data configured for generating the passed data originates from the network or locally. In the latter, because the passed data is generated based on the original data, when the original data originates from the network or locally, it may also be considered that the passed data originates from the network or locally. Therefore, when the passed data has the data source tag, regardless of whether the passed data is directly obtained from the network or locally, or obtained by performing a series of processing on the original data, it may be considered that the passed data originates locally or from the network.

When it is determined that the passed data originates locally or from the network, it may be determined that the current execution function of the preset candidate function type for detection is to process data that originates from the network or locally. The current execution function of the preset candidate function type for detection is a function related to a hot update behavior. For example, the current execution function may be a class loading function or a library loading function in the hot update. Therefore, when it is determined that the passed data executed by the current execution function originates from the network or locally and is not from the original installation package, it may be considered that new unverified code has been injected into the application, and the application is undergoing the hot update based on the new unverified code.

In an embodiment, if the passed data does not have the data source tag, it may be considered that the passed data is generated outside a management scope of the detection system, or it may be considered that the passed data is data internally generated by the customized Android system. In this case, the detection system does not determine that the application undergoes the hot update, but allows the application to continue execution, that is, the virtual machine continues to execute a next machine executable instruction.

In an embodiment, after it is determined that the application undergoes the hot update, a hot update record may be generated based on the passed data and the data source tag obtained from the tag storage location of the passed data, and the hot update record is transmitted to the detection platform. Detailed information about the hot update may be recorded in the hot update record, to provide a detailed basis for subsequent analysis, auditing, and compliance inspection.

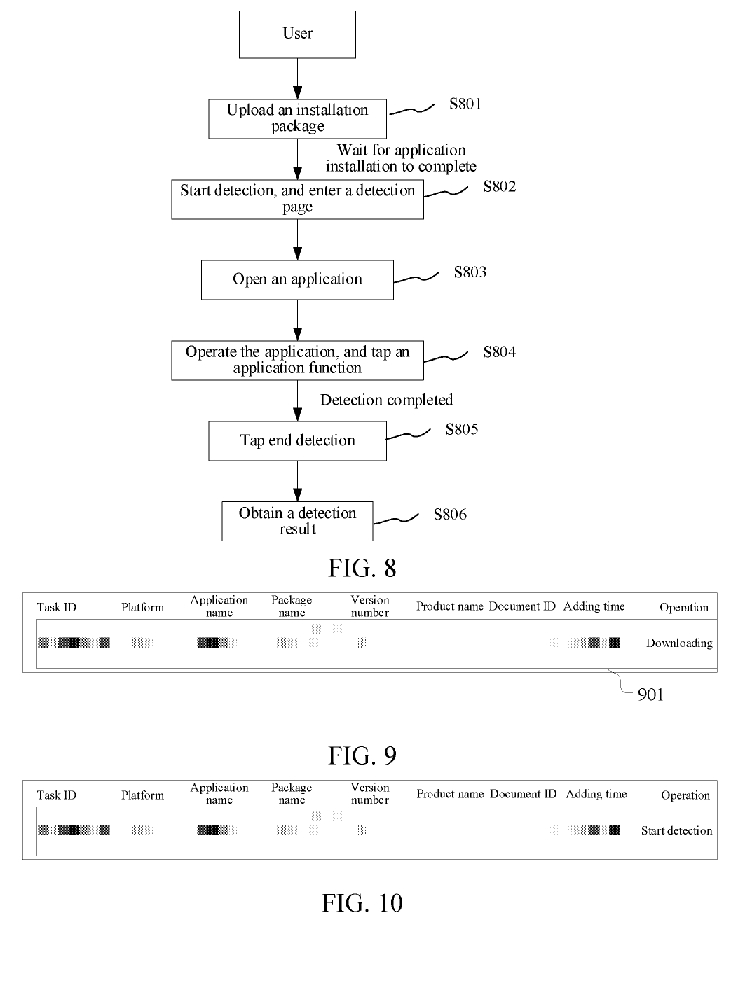

In an embodiment, FIG. 8 is a schematic overall flowchart of a hot update detection method according to an embodiment. S801: A user may upload an installation package of an application to a detection platform, so that the detection platform may trigger a virtual terminal to install the application by using the installation package. S802: Enter a detection page when the application starts to be detected. S803: Open the application in the detection page. S804: The user may operate the application and use various functions of the application. S805: After tapping a detection stop control, in S806, the user may obtain a detection result and determine, based on the detection result, whether the application undergoes a hot update. When the application does not undergo the hot update, there is no hot update record in the detection result, so that the user may determine, based on the detection result, that the application does not undergo the hot update. When the application undergoes the hot update, there is a hot update record in the detection result obtained by the user, so that the user may determine, based on the detection result, that the application undergoes the hot update.

In the foregoing hot update detection method, a machine executable instruction currently being executed is determined in a running process of the application, a current execution function may be determined based on the machine executable instruction currently being executed, and a function type of the current execution function may be determined by determining the current execution function. When it is determined that the current execution function is of a preset candidate function type for detection, it is determined that a hot update behavior may occur at this moment, and passed data passed to the current execution function is obtained. When the passed data originates locally or from a network other than an original installation package, it is determined that the application undergoes the hot update, thereby achieving automatic hot update detection in the running process of the application. In a process of executing a series of execution functions based on original data of the application, a tag storage location of data generated based on any execution function may record a data source tag of data passed to the any execution function, so that after the passed data passed to the current execution function is obtained, a tag storage location of the passed data may be further determined. When a data source tag is obtained from the tag storage location of the passed data, it is determined that the application undergoes the hot update, and the obtained data source tag is configured for indicating that the passed data originates locally or from the network other than the original installation package. Therefore, in the solution of the present disclosure, a source of data passing is determined, and with reference to a precise function type and a data tagging mechanism, an algorithm can efficiently and accurately identify whether a hot update occurs. In comparison with a typical hot update detection method by manually analyzing an installation package file, the present disclosure improves efficiency of hot update detection.

In an embodiment, the application runs on the virtual terminal, and the application is obtained by triggering, based on a preset installation instruction after an installation package of the application is uploaded to the detection platform via an installation package upload page, the virtual terminal to install the installation package.

Specifically, before the application is detected, the application may further be installed in the virtual terminal. The detection platform may have an installation package uploading control. For example, the installation package uploading control may be specifically an installation package uploading button. After the user triggers the installation package uploading control, the detection platform may display the installation package upload page, so that the user may upload the installation package of the application via the installation package upload page. For example, the user may drag the installation package of the application to the installation package upload page and tap an upload button. After it is determined that the user uploads the installation package via the installation package upload page, the detection platform may detect validity of the installation package, and upload the installation package to a detection queue after validity detection succeeds. Further, after the installation package is successfully uploaded to the detection queue, the detection platform may automatically trigger installation of the application on the virtual terminal.

In an embodiment, after the user drags the installation package of the application to the installation package upload page and taps the uploading button, the detection platform may transmit the installation package of the application to the detection queue in a cloud, display a task information row corresponding to the application in a task center, and display an operation identifier in the task information row. FIG. 9 is a schematic diagram of a task center according to an embodiment. In a process of transmitting the installation package to the cloud, the task center may display a task information row 901 corresponding to the application. The task information row displays a task identifier of a detection task executed for the application, an application name, a version number, an installation package name, task adding time, and an operation identifier. The operation identifier is specifically "Downloading". By displaying the operation identifier in a form of "Downloading", the user may be prompted, based on the operation identifier, that the installation package is being uploaded.

In an embodiment, after the installation package is uploaded, referring to FIG. 10. The operation identifier in the task center may be changed from "Downloading" to "Start detection". After the user taps "Start detection", the detection platform may display a terminal interface of the virtual terminal, and display an application icon of the application on the terminal interface. After the user taps the application icon, the virtual terminal may display an application interface of the application. FIG. 10 is a schematic diagram of a task center according to another embodiment. For example, an event detector is disposed for the "Start detection" control, and the event detector is configured to detect a trigger operation on the "Start detection" control. When the event detector detects that the "Start detection" control is triggered, for example, when the event detector detects that the "Start detection" control is tapped, the event detector may generate a tap event broadcast, and transmit the tap event broadcast to the virtual terminal, so that after receiving the tap event broadcast, the virtual terminal may determine, based on the tap event broadcast, that the "Start detection" control is tapped, and may further display the terminal interface including the application icon.

In an embodiment, the detection platform may display a plurality of candidate installation package identifiers, for example, display a plurality of candidate installation package names. The user may select one candidate installation package identifier, so that the detection platform uses the candidate installation package identifier selected by the user as a target installation package identifier, downloads, from an application store, an installation package corresponding to the target installation package identifier, and installs the downloaded installation package in the virtual terminal.

In an embodiment, after the installation package is uploaded, the detection platform may create a virtual terminal. The virtual terminal uses a customized Android system image. The Android system image creates a clean detection environment in the virtual terminal, and starts to install the installation package submitted by the user. An installation process is recorded in detail, to facilitate subsequent analysis of behaviors and performance of the application. Creating the clean detection environment in the virtual terminal can improve detection accuracy and reduce impact of ambient noise on detection.

In an embodiment, after the installation package is uploaded, the virtual terminal automatically triggers an installation procedure. For example, after the installation package is uploaded to the cloud, the detection platform may trigger, based on an installation instruction, the virtual terminal to install the installation package, to obtain the application running in the virtual terminal. For example, the detection platform may install the installation package in the virtual terminal based on an "adb install" instruction.

In an embodiment, before the virtual terminal is triggered, based on the installation instruction, to install the application, the detection platform may obtain access permission of the virtual terminal, so that the virtual terminal can be subsequently triggered, based on the installation instruction, to install the application.

In the foregoing embodiments, the installation package of the application may be uploaded via the installation package upload page by displaying the installation package upload page. After the installation package is uploaded, the virtual terminal may automatically install the application based on the installation package, to improve installation convenience of the application.

In an embodiment, when the passed data is generated based on the original data, the data source tag of the original data is recorded at the tag storage location of the passed data. An operation of generating the data source tag of the original data includes: determining, when the original data is obtained from the network, that the data source tag of the original data is a first tag configured for indicating a network source; and determining, when the original data is obtained locally, that the data source tag of the original data is a second tag configured for indicating a local source.

The original data is reference data configured for generating other data in the running process of the application. The original data may be data obtained from the network based on a network request, data read from a local file system, or data read from a local database.

Specifically, the passed data passed to the current execution function may be generated based on the original data. For example, the original data may be processed to obtain intermediate data, and then the intermediate data is processed to obtain the passed data. A manner of data processing includes but is not limited to copying, adding data content, deleting data content, modifying data content, combining data content, and the like. In this case, the data source tag of the passed data includes the data source tag of the original data. That is, regardless of how the original data flows in the running process of the application, data obtained based on the original data includes the data source tag of the original data. In other words, during data flow, the data source tag of the original data is passed together with the original data. For example, after obtaining the original data and determining the data source tag of the original data, the original data may be passed from one operation to another operation in the running process of the application to obtain first intermediate data based on the original data. In this case, a tag storage location of the first intermediate data records the data source tag of the original data. For example, when the original data is copied to obtain the first intermediate data, the data source tag of the original data is recorded at the tag storage location of the first intermediate data.

Further, if the first intermediate data is passed from one operation to another operation to obtain second intermediate data based on the first intermediate data, a data source tag of the second intermediate data includes the data source tag of the first intermediate data. For example, when a value of the first intermediate data is modified to obtain the second intermediate data, the data source tag of the first intermediate data is recorded at a tag storage location of the second intermediate data. The data source tag extracted from the tag storage location of the first intermediate data may be referred to as the data source tag of the first intermediate data. Further, because the data source tag of the original data is recorded at the tag storage location of the first intermediate data, the data source tag of the original data is also recorded at the tag storage location of the second intermediate data. In this way, data may be passed for a plurality of times, to finally obtain the passed data. In this case, the data source tag of the original data may also be recorded at the tag storage location of the passed data.

During data flow, the data source tag of the original data is passed together with the original data. Therefore, the data source tag of the original data needs to be determined after the original data is obtained. When the original data is obtained from the network, the data flow determining system may determine that the data source tag of the original data is the first tag. When the original data is obtained locally, the detection system may determine that the data source tag of the original data is the second tag. The first tag is a tag configured for indicating that data is obtained from the network, and the second tag is a tag configured for indicating that data is obtained locally. For example, the first tag may be "network", and the second tag may be "local".

In an embodiment, data obtained in a process of starting an application is referred to as original data, and a data source tag of the original data is determined.

In an embodiment, a machine executable instruction configured for obtaining the original data may be determined, and when it is determined, based on the machine executable instruction, that a network request has been transmitted, it may be determined that the original data is obtained based on the network request. In this case, the first tag is used as the data source tag of the original data.

In an embodiment, a machine executable instruction configured for obtaining the original data may be determined, and when it is determined, based on the machine executable instruction, that a local file system is accessed, or that a local database is accessed, it may be determined that the original data is obtained from the local file system, or that the original data is obtained from the local database. In this case, the second tag is used as the data source tag of the original data.

In the foregoing embodiments, by determining the data source tag of the original data, the original data and the data source tag of the original data can be passed together during data flow. In this way, the data source tag of the passed data obtained based on the original data includes the data source tag of the original data, to determine a most original source of the passed data based on the tag that includes the data source tag of the original data. Because the most original source of the passed data can be determined based on the data source tag of the passed data, in the running process of the application, regardless of what data transformation is performed to obtain the passed data, the most original source of the passed data can be traced based on the data source tag.

In a hot update technology, to bypass compliance management, an application developer repeatedly processes information that a hot update file is not from an original installation package, so that an inspector mistakenly considers that the hot update file is from the original installation package, and consequently, whether an application undergoes a hot update cannot be detected. The hot update file is a file configured for hot updating. For example, the hot update file may be a patch. The present disclosure resolves the foregoing problem. In the present disclosure, for the passed data in the running process of the application, regardless of a series of operations by which the passed data is generated and obtained, the passed data may be traced back to the most original source. Therefore, the detection system may trace back to the most original source of the passed data, to determine whether the passed data originates from the original installation package or originates from the network or locally other than the original installation package, and determine that the application undergoes the hot update when determining that the passed data originates from the network or locally other than the original installation package.

In an embodiment, when the original data is obtained from the network, determining that the data source tag of the original data is the first tag configured for indicating the network source includes: obtaining a preset first function set, the first function set including a system call function that is supported by the application and that is configured for receiving network data; determining a data obtaining function configured for obtaining the original data; matching the data obtaining function with the system call function in the first function set; and determining, when the data obtaining function successfully matches the system call function in the first function set, that the original data is obtained from the network, and using the first tag as the data source tag of the original data.

Specifically, the data flow determining system may determine a function configured for obtaining the original data. For ease of description, the function configured for obtaining the original data is referred to as the data obtaining function below. The data flow determining system may further obtain the preset first function set. The first function set includes the system call function that is supported by the application and that is configured for receiving the network data. For example, the first function set includes a network interface call function, a network request transmitting function, a network request response function, and the like. Further, the data flow determining system matches the data obtaining function with the first function set, to determine whether the first function set includes a system call function matching the data obtaining function. If the first function set includes the system call function matching the data obtaining function, it is determined that the data obtaining function successfully matches the system call function in the first function set. In this case, it may be determined that the original data is obtained from the network.

In an embodiment, all system call functions that are supported by a kernel and that receive network data may be found in advance, for example, a recvfrom function, and the found system call functions are stored in the first function set.

In an embodiment, determining whether the first function set includes the system call function matching the data obtaining function may be specifically: determining whether the first function set includes a system call function consistent with the data obtaining function. The detection system may determine a function name of the data obtaining function. For ease of description, the function name of the data obtaining function is referred to as a data obtaining function name below. The detection system determines whether the first function set includes a system call function having a data obtaining function name, and if the first function set includes the system call function having the data obtaining function name, determines that the first function set includes the system call function consistent with the data obtaining function.

In an embodiment, in the running process of the application, if data is obtained based on the machine executable instruction currently being executed, whether the data has a data source tag may be determined. If the data does not have the data source tag, a function configured for obtaining the data may be determined. Whether the function configured for obtaining the data matches the first function set is determined by matching the function configured for obtaining the data with the first function set. When it is determined that the function configured for obtaining the data matches the first function set, it is determined that the data is the original data, and it is determined that the original data originates from the network, and the first tag is used as the data source tag of the original data. Correspondingly, if the data obtained based on the machine executable instruction currently being executed has the data source tag, it may be determined that the data is not original data.

In the foregoing embodiment, whether the original data originates from the network can be determined only by performing a matching operation, thereby improving efficiency of determining a data source of the original data.

In an embodiment, when the original data is obtained locally, determining that the data source tag of the original data is the second tag configured for indicating the local source includes: obtaining a preset second function set, the second function set including a system call function that is supported by the application and that is configured for file reading/writing; matching the data obtaining function with the system call function in the second function set; and determining, when the data obtaining function successfully matches the system call function in the second function set, that the original data is obtained locally, and using the second tag as the data source tag of the original data.

Specifically, the data flow determining system may determine a data obtaining function configured for obtaining the original data. The data flow determining system may further obtain a preset second function set. The second function set includes the system call function that is supported by the application and that is configured for file reading/writing. For example, the second function set includes a local file system access function, a local database access function, and the like. Further, the data flow determining system matches the data obtaining function with the second function set, to determine whether the second function set includes a system call function matching the data obtaining function. If the second function set includes the system call function matching the data obtaining function, it is determined that the data obtaining function successfully matches the system call function in the second function set. In this case, it may be determined that the original data is obtained locally. Determining whether the second function set includes the system call function matching the data obtaining function may be specifically: determining whether the second function set includes a system call function consistent with the data obtaining function.

In an embodiment, all system call functions that are supported by a kernel and that receive local data may be found in advance, for example, a read function, and the found system call functions are stored in the second function set.

In an embodiment, in the running process of the application, if data is obtained based on the machine executable instruction currently being executed, whether the data has a data source tag may be determined. If the data does not have the data source tag, a function configured for obtaining the data may be determined. Whether the function configured for obtaining the data matches the second function set is determined by matching the function configured for obtaining the data with the second function set. When it is determined that the function configured for obtaining the data matches the second function set, it is determined that the data is the original data, and it is determined that the original data originates locally, and the second tag is used as the data source tag of the original data.

In the foregoing embodiment, whether the original data originates locally can be determined only by performing a matching operation, thereby improving efficiency of determining a data source of the original data.

In an embodiment, the method further includes: generating, in a process of passing the passed data to a next execution function based on the current execution function, metadata of the passed data based on the data source tag extracted from the tag storage location of the passed data; and passing the passed data together with the metadata of the passed data to the next execution function.

Specifically, during data flow, the data source tag is passed together with the passed data. For example, when the passed data is passed to the next execution function based on the current execution function, the data flow determining system also passes the data source tag of the passed data to the next execution function. For example, the data determining system uses the data source tag of the passed data as the metadata of the passed data that is passed together with the passed data to the next execution function. The metadata is data configured for describing data.

In an embodiment, when the data flow determining system intercepts the machine executable instruction currently being executed, and determines, based on the machine executable instruction currently being executed, that the current execution function is configured for passing the passed data to the next execution function, the data flow determining system may generate the metadata of the passed data based on the data source tag of the passed data, and passes the metadata to the next execution function.

In an embodiment, when the passed data has metadata, the data source tag of the passed data may be added to the original metadata. When the passed data does not have metadata, the metadata of the passed data is generated based on the data source tag of the passed data.

For the passed data and all data generated in the running process of the application, the data and a data source tag of the data can be passed from one operation to another operation.

In the foregoing embodiments, the data source tag of the passed data is used as the metadata and passed together with the passed data, so that impact of passing the data source tag on normal functions of the application can be reduced, thereby detecting a hot update behavior of the application in a normal running process of the application. In this way, accuracy of hot update detection is improved.

In an embodiment, the method further includes: determining, when the passed data is processed based on the next execution function to obtain processed data, and the processed data is stored in the virtual machine stack, a storage location of the processed data in the virtual machine stack; determining a tag storage location of the processed data based on the storage location of the processed data in the virtual machine stack; and determining the data source tag extracted from the tag storage location of the passed data based on the metadata of the passed data, and storing the data source tag extracted from the tag storage location of the passed data at the tag storage location of the processed data.

Specifically, when the passed data is passed to the next execution function, the next execution function may process the passed data to obtain the processed data. When the processed data is stored in the virtual machine stack, the data flow determining system may determine the storage location of the processed data in the virtual machine stack, and determine, based on the storage location of the processed data in the virtual machine stack, a location at which the data source tag of the processed data is to be stored. For ease of description, the location at which the data source tag of the processed data is to be stored is referred to as the tag storage location of the processed data below. Further, because the metadata is data configured for describing data, the metadata of the passed data may be configured for describing a specific data source tag extracted from the tag storage location of the passed data. Therefore, the data flow determining system may determine the data source tag extracted from the tag storage location of the passed data based on the metadata of the passed data, and store the data source tag extracted from the tag storage location of the passed data at the tag storage location of the processed data.

In an embodiment, the data flow determining system may determine a stack frame of the processed data in the virtual machine stack, and determine a distance between the stack frame and the top of the virtual machine stack. For ease of description, the distance between the stack frame storing the processed data and the top of the virtual machine stack is referred to as a first distance below. The data flow determining system determines a middle location of the virtual machine stack, and uses a stack frame whose distance to the middle location is the first distance as a tag storage location. For example, the stack frame storing the processed data is a 3^{rd} stack frame whose distance to a 0^{th} stack frame is 3. The middle location of the virtual machine stack is an n^{th}stack frame, and the tag storage location of the processed data is an (n+3)^{th} stack frame. Then, the data flow determining system may determine the data source tag of the passed data based on the metadata of the passed data, and store the data source tag of the passed data at the (n+3)^{th} stack frame.

In the foregoing embodiments, the data source tag of the passed data is stored at the tag storage location of the processed data, so that the data source tag of the processed data includes the data source tag of the passed data. In this way, the data source tag propagates together with the data.

In an embodiment, the method further includes: adding, when the passed data is processed based on the next execution function to obtain processed data, and the processed data is a data object, a member variable to an extended structure of the processed data; and determining, based on the metadata of the passed data, the data source tag extracted from the tag storage location of the passed data, and using the data source tag extracted from the tag storage location of the passed data as a value of the added member variable.

Specifically, when the passed data is passed to the next execution function, the next execution function may process the passed data to obtain the processed data. When the processed data is the data object, the data flow determining system may add the member variable to the extended structure of the processed data, and use the data source tag extracted from the tag storage location of the passed data as the value of the added member variable. For example, a field for the processed data may be added, and the data source tag extracted from the tag storage location of the passed data is used as a value of the field. Alternatively, an attribute for the processed data may be added, and the data source tag extracted from the tag storage location of the passed data is used as a value of the attribute.

In an embodiment, the added member variable may be a variable indicating the data source tag of the processed data. When the data source tag of the passed data is used as a value of the added member variable, the data source tag of the processed data may include the data source tag of the passed data. For example, the added member variable may be "tagged=network", and "network" is a data source tag of the passed data. When a data source tag of the processed data needs to be determined, "tagged=network" may be extracted from the extended structure of the passed data based on a keyword "tagged".

In the foregoing embodiments, the data source tag of the passed data is used as the value of the added member variable of the processed data, so that the data source tag of the processed data includes the data source tag of the passed data. In this way, the data source tag propagates together with the data.

For the passed data, the processed data, and all data generated in the running process of the application, a data source tag may be processed based on the foregoing manner. For example, in a process of executing a series of execution functions, for data generated based on any execution function, when the data is stored in the virtual machine stack, a tag storage location of the data may be determined based on a storage location of the data in the virtual machine stack, and a data source tag of data passed to the any execution function is stored at the tag storage location of the data generated based on the any execution function. For another example, in a process of executing a series of execution functions, for data generated based on any execution function, when the data is a data object, a member variable may be added to an extended structure of the data, and a data source tag of data passed to the any execution function is used as a value of the added member variable.

In an embodiment, when the next execution function is an operation function, in addition to passing the passed data to the next execution function, other data is further passed to the next execution function. For ease of description, data, other than the passed data, that is passed to the next execution function, is referred to as operation data below. In the process of passing the passed data to the next execution function, the data source tag of the passed data is also passed to the next execution function, and in a process of passing the operation data to the next execution function, a data source tag of the operation data is also passed to the next execution function. Further, the next execution function performs data operation processing on the passed data and the operation data, to obtain the processed data. When the processed data is stored in the virtual machine stack, the data source tag of the passed data and the data source tag of the operation data are both stored in the virtual machine stack storing the processed data. When the processed data is a data object, a plurality of member variables are added to the extended structure of the processed data. A value of one member variable is the data source tag of the passed data, and a value of another member variable is the data source tag of the operation data. For example, member variables "tagged_1=data source tag of passed data" and "tagged_2=data source tag of operation data" may be generated.

In an embodiment, when the processed data is passed to a next function, and the next function is of the preset candidate function type for detection, the detection system needs to extract the data source tag of the processed data, and determine, based on the data source tag of the processed data, whether the application undergoes the hot update. When the data source tag of the processed data needs to be extracted, if the processed data is stored in the virtual machine stack, the data source tag of the processed data is extracted from the virtual machine stack. For example, in the foregoing example, all data source tags may be extracted from the (n+3)^{th} stack frame, and all the extracted data source tags are used as data source tags of the processed data. If the processed data is a data object, the data source tag of the processed data may be extracted from the extended structure of the processed data. For example, in the foregoing example, "tagged_1=data source tag of passed data" and "tagged_2=data source tag of operation data" may be extracted from the extended structure of the processed data based on the keyword "tagged", and values of the extracted member variables are used as data source tags of the processed data.

In an embodiment, the application runs on the virtual terminal; when the virtual machine in the virtual terminal runs in an interpretation execution mode, in the running process of the application, a data source tag passing instruction configured for passing a data source tag is inserted each time after execution of an original machine executable instruction; and when the virtual machine in the virtual terminal runs in a compilation execution mode, in a process of compiling the application by using a compiler of the virtual machine, the data source tag passing instruction configured for passing the data source tag is inserted.

Specifically, when the virtual machine of the customized Android system executes application code in an interpretation mode, the virtual machine interprets execution instructions one by one. In this process, the data flow determining system needs to ensure that data related to all instructions carries a data source tag previously tagged. This means that the data flow determining system needs to intercept execution of each machine executable instruction during running, check the data source tag, and pass, when data is passed from one operation to another operation, the data source tag together with the data by using the inserted data source tag passing instruction.

In addition to the interpretation execution mode, the virtual machine also supports the compilation execution mode, so that some or all code of the application is compiled into local machine code during installation. To implement data flow capture in the compilation execution mode, the compiler needs to insert an additional data source tag passing instruction into the generated machine code, to pass the data source tag. The data source tags need to be designed to be sufficiently efficient, to avoid a significant impact on application performance. In addition, the data source tags are capable of accounting for all possible paths of a data flow during compilation, to ensure that detection of a hot update behavior does not miss any critical data flow due to a compilation process.

In an embodiment, the method further includes: determining, when a tag set is extracted from the tag storage location of the passed data, a data source of the passed data based on a data source tag in the tag set; determining the data source of the passed data based on the data source tag in the tag set; and generating a hot update record based on the data source of the passed data, the passed data, and the data source tag in the tag set.

Specifically, a plurality of data source tags may be stored at the tag storage location of the passed data. That is, the tag set may be extracted from the tag storage location of the passed data. For example, when data A and data B are combined to obtain passed data C, a data source tag of data A and a data source tag of data B may be recorded at a tag storage location of the passed data C. In this case, the tag set is extracted from the tag storage location of the passed data. The detection system may determine a data source of the passed data based on the tag set, and generate the hot update record based on the data source of the passed data, the passed data, and a tag in the tag set. In this case, the data source of the passed data is the most original source of the passed data traced by the detection system. Further, the detection system may transmit the hot update record to the detection platform, so that the detection platform may display the hot update record, and further, the user may determine, based on the displayed hot update record, whether the application undergoes the hot update.

When the data source tag of the passed data is not a tag set, but only one data source tag, the hot update record is generated based on the passed data and the data source tag of the passed data.

In an embodiment, when the passed data is data passed to the class loading function or the library loading function, and the data source tag of the passed data indicates that the passed data originates locally or from the network, it may be determined that the application undergoes the hot update, so that the detection system may record the passed data together with the data source tag of the passed data in one log, and the log is the hot update record.

In an embodiment, the detection system may further record, in the hot update record, a specific source address of the passed data, a time stamp when the passed data is passed to the class loading function or the library loading function, specific data content of the passed data, and other metadata of the passed data.

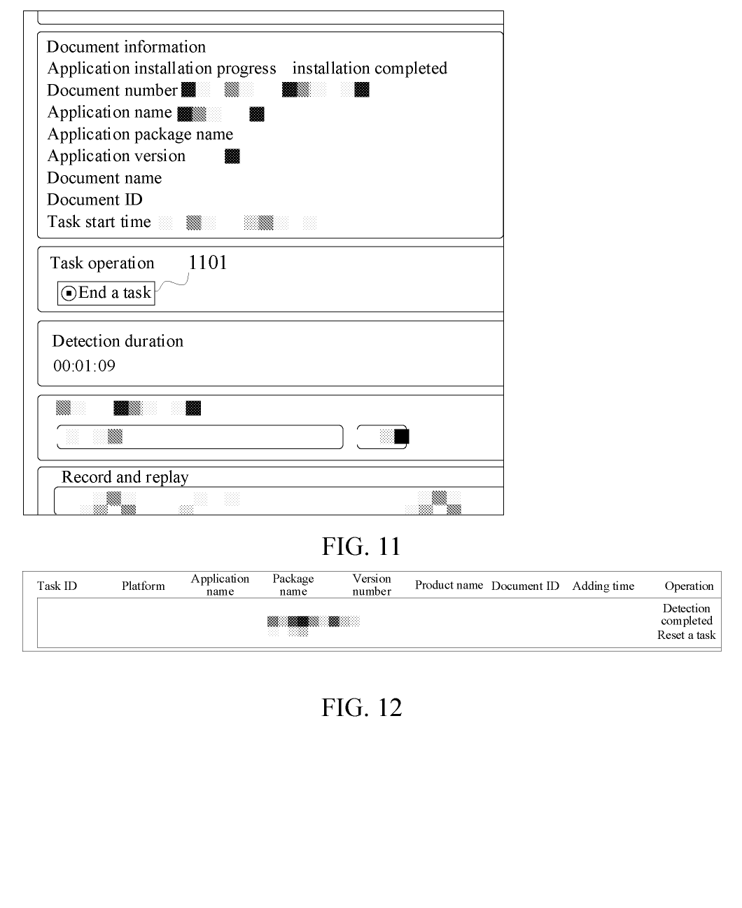

In an embodiment, each time a hot update record is generated, the hot update record may be immediately transmitted to the detection platform. Alternatively, after completion of a detection task, generated hot update records may be summarized to obtain a summary record, and the summary record may then be transmitted to the detection platform. For example, referring to FIG. 11. An "End task" control 1101 may be displayed on the detection platform. When the user taps the "End task" control, the detection system may transmit the summary record to the detection platform. In this case, the detection platform may display a preview control and a download control. The summary record may be previewed through the preview control, and the summary record may be downloaded through the download control. FIG. 11 is a schematic diagram of a detection page of a detection platform according to an embodiment.

Referring to FIG. 11. In addition to the "End task" control displayed on the detection page of the detection platform, document information of a detection task may further be displayed. The document information is information about a document, and the document is a document submitted for the detection task. The document information may include information such as an application installation progress, a document number, an application name, an application package name, a document name, a document ID, and task start time. Displaying the document information is convenient for the user to comprehensively understand related information of the detection task. Before tapping the "End task" control, the user may use the application, so that the virtual terminal correspondingly displays the application interface of the application.

In an embodiment, referring to FIG. 12. After the user taps the "End task" control, content in an operation item of the task center changes from "Detecting" to "Detection completed, reset task". FIG. 12 is a schematic diagram of a task center according to another embodiment.

In the foregoing embodiments, the hot update record is generated, and the hot update record may be transmitted to the detection platform, so that it is convenient for the user to obtain the hot update record through the detection platform, analyze the hot update behavior of the application based on the hot update record, understand the hot update behavior of the application, and output security measures for the hot update behavior of the application.

In one of the embodiments, the data source tag includes the first tag and the second tag, the first tag being configured for indicating the network source, and the second tag being configured for indicating the local source; and determining the data source of the passed data based on the data source tag in the tag set includes: determining, when the tag set includes the first tag, that the data source of the passed data is the network; or determining, when the tag set includes the second tag, that the data source of the passed data is local.

Specifically, if the tag set includes the first tag, it may be determined that the data source of the passed data is the network. For example, if the first tag is "network", the second tag is "local", and the tag set includes "network" and "local", it may be considered that the original data is first obtained from the network, the original data is stored locally, then the original data is read locally, and the original data is processed, to obtain the passed data. When the tag set includes only the second tag, it is determined that the data source of the passed data is local. When the tag set includes only the first tag, it is determined that the data source of the passed data is the network.

In an embodiment, generating the hot update record based on the data source of the passed data, the passed data, and the data source tag in the tag set includes: obtaining, when determining that the data source of the passed data is the network, a network request that is transmitted by the application in the running process and that is related to the passed data; determining a network link carried in the network request, and matching the network link with a preset official application update link, to obtain a matching result; and generating, when determining, based on the matching result, that the application does not undergo the hot update through an official update channel, the hot update record based on the matching result, the data source, the passed data, and the data source tag in the tag set.

Specifically, when it is determined that the data source of the passed data is the network, the detection system may obtain all network requests transmitted by the application in the running process, and filter, based on the passed data, a target network request related to the passed data from all the obtained network requests. The target network request related to the passed data is a network request configured for obtaining the passed data, or a network request configured for obtaining the original data for generating the passed data.

Further, the detection system may extract a network link from the target network request, and match the network link with the preset official application update link. When the network link matches the preset official application update link, for example, when the network link is consistent with the preset official application update link, it may be determined that the application is updated through the official channel. When the network link does not match the preset official application update link, for example, the network link is inconsistent with the preset official application update link, it may be determined that the application is updated through an unofficial channel. In this case, the detection system generates the hot update record based on the matching result, the data source, the passed data, and the tag in the tag set, so that the user determines, based on the hot update record, that the application undergoes the hot update through the unofficial channel.

In this embodiment, the matching result between the network link and the preset official application update link is determined, and the hot update record may be generated based on the matching result. Generating the hot update record may be convenient for the user to determine, based on the hot update record, whether the application undergoes the hot update through the unofficial channel.

In an embodiment, the user may detect a plurality of applications at once, for example, a plurality of virtual terminals may be created, one application may run in each virtual terminal, the user may operate each application, and in a process in which the user operates the application in the virtual terminal, a hot update behavior of each application may be detected.

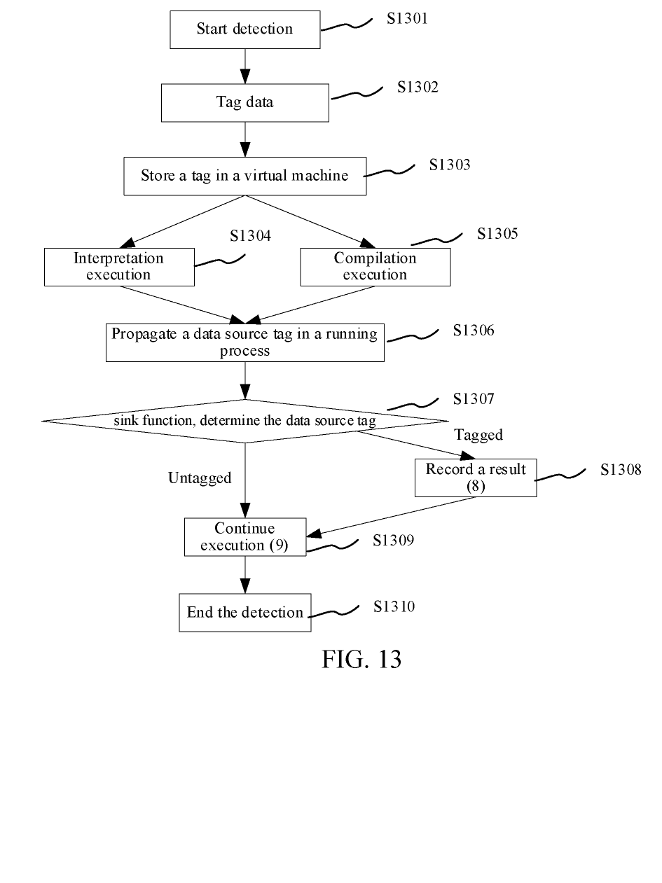

In an embodiment, FIG. 13 is a schematic overall flowchart of a hot update detection method according to an embodiment. S1301: When a user taps a "Start detection" control, start detection of an application. S1302: When the application obtains data from a network, set a data source tag of the data as a first tag; and when the application obtains data locally, set a data source tag of the data as a second tag. S1303: Store the data source tag in a virtual machine. S1304: If the virtual machine runs in an interpretation execution mode, in S1306, propagate the data source tag together with the data in a running process of the application. S1305: If the virtual machine runs in a compilation execution mode, in S1306, propagate the data source tag together with the data in the running process of the application. S1307: When a current execution function is of a preset function type, determine whether data input into the current execution function has a data source tag. S1308: If the data input into the current execution function has the data source tag, generate a hot update record based on the data input into the current execution function and the data source tag of the data. If the data input into the current execution function does not have the data source tag, perform S1309 to continue to execute the application. S1310: When an "End task" control is tapped, end the detection of the application.

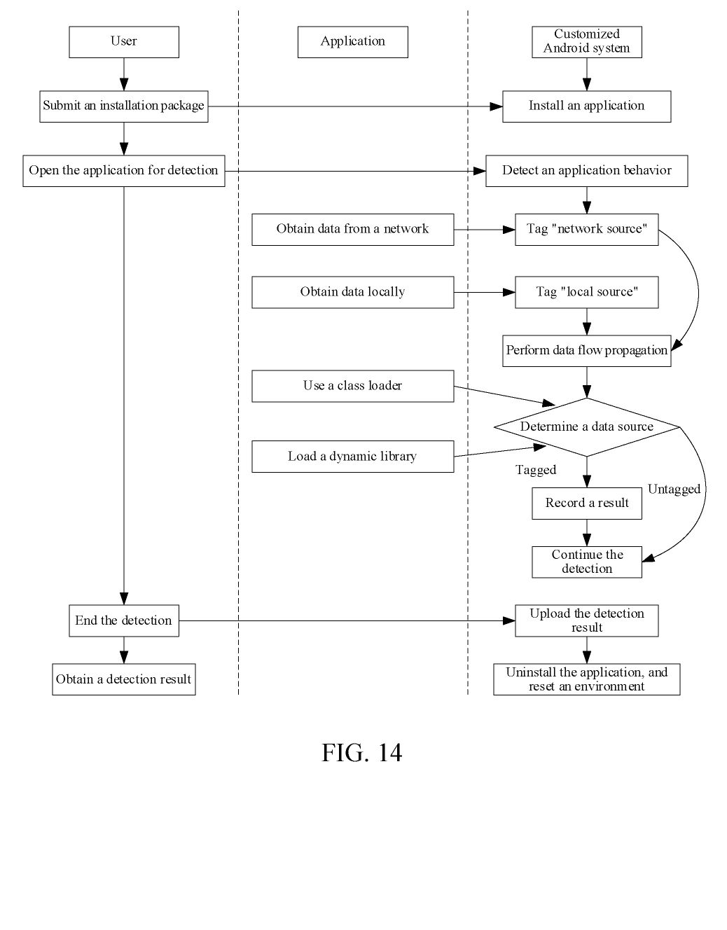

In an embodiment, FIG. 14 is a schematic interaction diagram of a hot update detection method according to an embodiment. A user may submit an installation package to a customized Android system, and the customized Android system may install an application based on the installation package. After the application is installed, the user may open the application for detection, and the customized Android system may determine a behavior of the application. When the application obtains data from a network, the customized Android system tags the data as a network source. When the application obtains data locally, the customized Android system tags the data as a local source. The customized Android system passes the data in a running process of the application. When a class loading function or a library loading function is called, the customized Android system may determine passed data passed to the class loading function or the library loading function, and determine whether the passed data has a data source tag. If the passed data has the data source tag, a hot update record is generated, and the detection is continued. After the detection ends, a detection result is uploaded, the application is uninstalled, and an environment is reset. The execution operations corresponding to the application may be operations executed based on original code in an original installation package. Operations performed by the customized Android system may be additional execution operations added in the present disclosure.

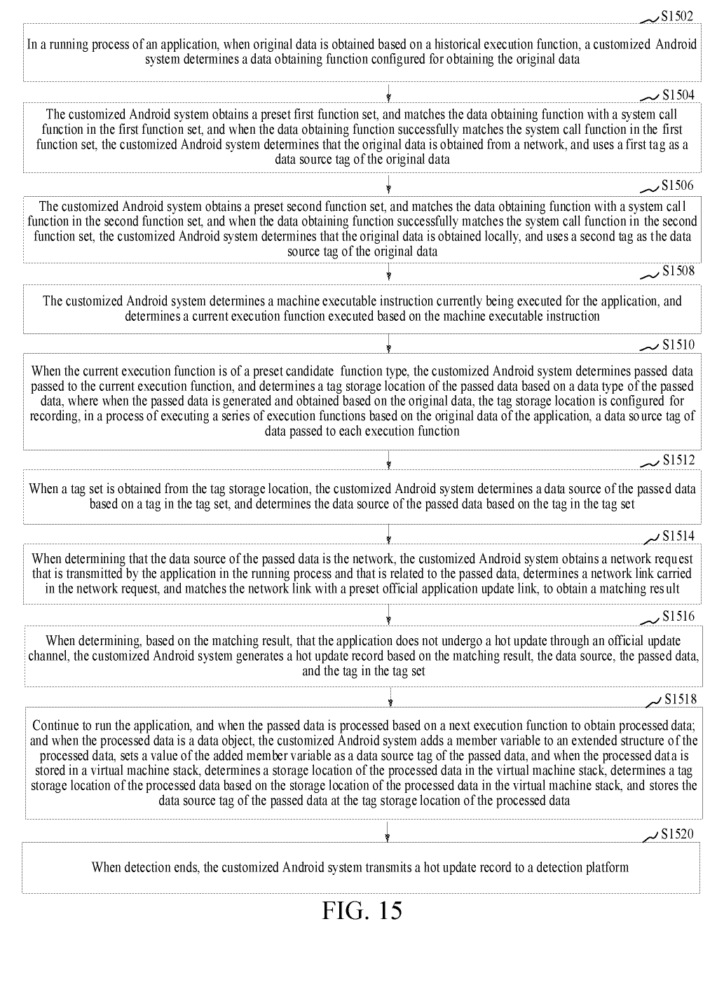

In an embodiment, FIG. 15 is a schematic flowchart of a hot update detection method according to a specific embodiment.

S1502: In a running process of an application, when original data is obtained based on a historical execution function, a customized Android system determines a data obtaining function configured for obtaining the original data.

S1504: The customized Android system obtains a preset first function set, and matches the data obtaining function with a system call function in the first function set, and when the data obtaining function successfully matches the system call function in the first function set, the customized Android system determines that the original data is obtained from a network, and uses a first tag as a data source tag of the original data.

S1506: The customized Android system obtains a preset second function set, and matches the data obtaining function with a system call function in the second function set, and when the data obtaining function successfully matches the system call function in the second function set, the customized Android system determines that the original data is obtained locally, and uses a second tag as the data source tag of the original data.

S1508: The customized Android system determines a machine executable instruction currently being executed for the application, and determines a current execution function executed based on the machine executable instruction.

S1510: When the current execution function is of a preset candidate function type for detection, the customized Android system determines passed data passed to the current execution function, and determines a tag storage location of the passed data based on a data type of the passed data, where when the passed data is generated and obtained based on the original data, the tag storage location is configured for recording, in a process of executing a series of execution functions based on the original data of the application, a data source tag of data passed to each execution function.

S1512: When a tag set is obtained from the tag storage location, the customized Android system determines a data source of the passed data based on a tag in the tag set, and determines the data source of the passed data based on the tag in the tag set.

S1514: When determining that the data source of the passed data is the network, the customized Android system obtains a network request that is transmitted by the application in the running process and that is related to the passed data, determines a network link carried in the network request, and matches the network link with a preset official application update link, to obtain a matching result.

S1516: When determining, based on the matching result, that the application does not undergo a hot update through an official update channel, the customized Android system generates a hot update record based on the matching result, the data source, the passed data, and the tag in the tag set.

S1518: Continue to run the application, and process the passed data based on a next execution function to obtain processed data; and when the processed data is a data object, the customized Android system adds a member variable to an extended structure of the processed data, sets a value of the added member variable as a data source tag of the passed data, and when the processed data is stored in a virtual machine stack, determines a storage location of the processed data in the virtual machine stack, determines a tag storage location of the processed data based on the storage location of the processed data in the virtual machine stack, and stores the data source tag of the passed data at the tag storage location of the processed data.

S1520: When detection ends, the customized Android system transmits a hot update behavior record to a detection platform.

Although operations in flowcharts described in the foregoing embodiments are displayed in sequence as indicated by arrows, these operations are not necessarily performed in sequence as indicated by the arrows. Unless otherwise explicitly specified in the present disclosure, execution of the operations is not strictly limited, and the operations may be performed in other sequences. Moreover, at least a part of the operations in the flowcharts in the foregoing embodiments may include a plurality of operations or a plurality of stages. The operations or stages are not necessarily performed at the same moment, but may be performed at different moments. The operations or stages are not necessarily performed sequentially, but may be performed alternately with other operations or at least a part of operations or stages of other operations.

The present disclosure further provides an application scenario. The foregoing hot update detection method is applied to the application scenario. Specifically, application of the hot update detection method in the application scenario is as follows.

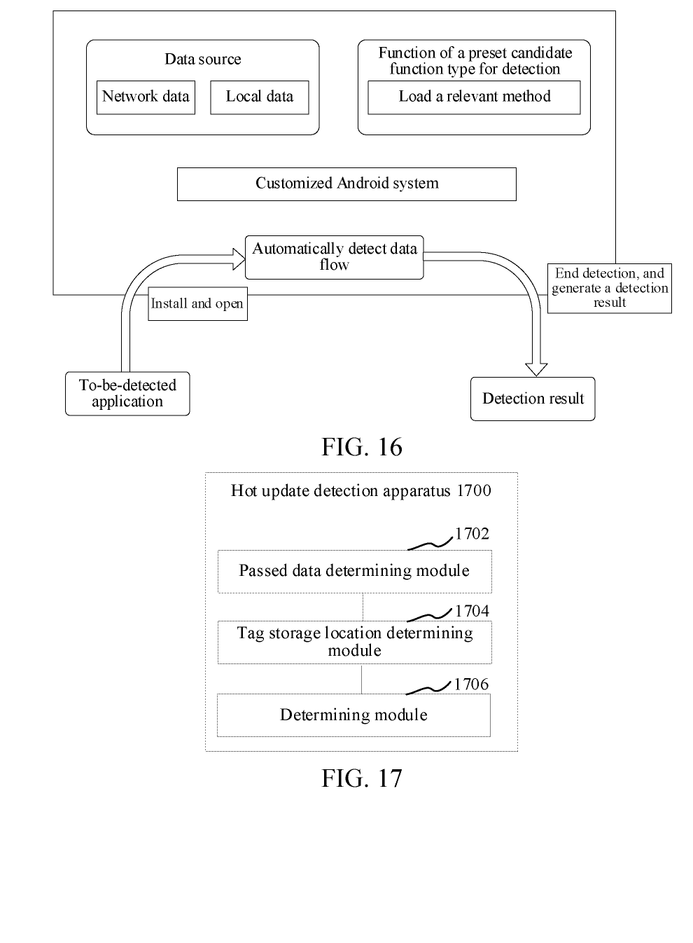

Hot update detection may be performed on an application in an application store. For an overall framework of the hot update detection method, referring to FIG. 16. More specifically, 1. Start detection:

In a data flow determining system of hot update detection, start of the detection is the beginning of an entire process. First, initialization is performed to configure a necessary management environment and to start real-time hot update detection for an application. Initialization of the detection includes loading a detection component, setting a data collection parameter, defining an update event trigger point, and configuring a logging method. In addition, a system may ensure that all necessary permission have been obtained, to detect an application behavior without obstruction.

2. Tag original data:

Tagging of data is a key operation in determining data flow. In this operation, a data flow determining system tags all data that may be related to a hot update, for example, data obtained from a file system, data obtained through a network interface, or data obtained from a local database. The tags are special metadata or identifiers configured for identifying a source of the original data in a subsequent data flow. In the tagging process, it needs to be ensured that normal functions of the application are not affected.

3. Store a data source tagin a virtual machine stack or in an extended structure of an object:

Once data is tagged, tag information needs to be stored in a traceable location. In an Android application, this is usually implemented by storing a data source tag in a virtual machine stack or in an extended structure (for example, a field or an attribute) of an object. In this way, it can be ensured that during data flow, the data source tag can be passed together with the data, and can be retrieved and analyzed at any time.

4. In an interpretation execution mode, an Android virtual machine propagates instruction-related data source tags one by one as follows:

When the Android virtual machine executes application code in an interpretation mode, the Android virtual machine interprets execution instructions one by one. In this process, the data flow determining system needs to ensure that data related to all instructions carries a data source tag previously tagged. This means that the data flow determining system needs to intercept execution of each instruction during running, check the data source tag of the data, and pass, when the data is passed from one operation to another operation, the data source tag together with the data. This facilitates subsequent analysis of a hot update behavior.

5. When the Android virtual machine is in a compilation execution mode, a compiler adds a data source tag passing instruction to a compilation instruction:

In addition to an interpretation execution mode, the virtual machine also supports the compilation execution mode, so that a part or all of code of the application is compiled into local machine code during installation. The compiler needs to insert an additional instruction into the generated machine code, to propagate the data tag. The instructions need to be designed to be sufficiently efficient, to avoid a significant impact on application performance. In addition, the data source tags are capable of accounting for all possible paths of a data flow during compilation, to ensure that detection of a hot update behavior does not miss any critical data flow due to a compilation process.

6. When the virtual machine runs, propagate the data source tag with the data:

In a running environment of an application, the virtual machine is a key component responsible for executing application bytecode. To determine a flow direction of data in the application, especially during the hot update, a mechanism is implemented to embed the data source tag in the virtual machine. The tags are propagated as metadata together with application data without affecting the normal functions of the application. To pass the data source tag, a data operation instruction in the virtual machine may be enhanced, to ensure that the data source tag correctly flows with the data when the data is computed or passed.

7. When the system executes a sink function, read a tag, and determine a sink source:

The sink function includes a class loading function or a dynamic library loading function. When a program executes the sink function, the detection system intervenes, and reads a data source tag passed to the function. The detection system can determine a data source by analyzing the data source tag. This operation is particularly critical for detecting the hot update behavior, as the operation can disclose whether updated data originates from an uncontrollable channel such as a network. If the data source tag indicates that the data originates from the network or locally, and is inconsistent with an official application update channel, the detection system records this behavior, to obtain the hot update record.

8. If the data source tag is a network or local, record a result, and continue execution:

Once the detection system determines that data is from the network or a local file system, and the data is related to the hot update behavior, the detection system records related information. The information includes a specific source address, a time stamp, updated content, and other related metadata of the data. While recording the result, the detection system does not prevent further processing of the data, but allows the program to continue execution. This non-intrusive method ensures that the normal functions of the application are not affected due to intervention of a detection process.

9. If there is no data source tag, continue execution:

In some cases, the data passed to the sink function may not have a data source tag. This may be because the data is generated outside a management scope of the detection system, or is internally generated by the system. In this case, the detection system chooses not to perform any recording, but allows the program to continue execution.

10. End the detection:

After detecting the functions, the user taps an "End detection" button, and in this case, the detection ends. The detection platform summarizes all recorded hot update behaviors and generates a report. This report provides valuable insight for an application developer or a security analyst, helping understand the hot update behaviors of the application, and take corresponding security measures.

The present disclosure has the following beneficial technical effects:
1. Enhanced application security: It can be ensured that no malicious code is introduced during updating by detecting and analyzing hot update behaviors. This helps protect users from security threats such as privacy leakage, data theft, or other potential malicious behaviors.
2. Ensured transparency: The technology can determine an exact source of code, and ensure that a hot update process is transparent, so that both developers and users can understand an origin and a purpose of code being executed.
3. Compliance review: Detecting hot update behaviors can help ensure that application updates comply with relevant regulations, to reduce risks caused by non-compliant updates.
4. Increased user trust: Users may be skeptical of non-transparent hot updates. Providing a method that can accurately detect and report hot update behaviors can increase user trust in the application.
5. Optimized update procedure: By detecting hot update behaviors, potential problems during updating can be identified and optimized accordingly, thereby improving application performance and user experience.
6. Abuse prevention: Sometimes, a hot update mechanism is used to bypass a review mechanism of an application store. The detection method helps prevent such abuse and ensures that all updates undergo proper review.
7. Market order maintenance: Healthy development of an application market can be maintained by ensuring proper use of a hot update mechanism, to avoid unfair competition caused by improper updates.
8. Data flow transparency: Developers and regulatory authorities can gain a clearer understanding of the data flow within an application, thereby better protecting user data and privacy.

Based on a same inventive concept, embodiments of the present disclosure further provide a hot update detection apparatus configured to implement the foregoing hot update detection method. An implementation provided by the apparatus for resolving a problem is similar to the implementation described in the foregoing method. For specific limitations of the following one or more embodiments of the hot update detection apparatus, refer to the limitations of the foregoing hot update detection method. Details are not described herein again.

In an embodiment, as shown in FIG. 17, a hot update detection apparatus 1700 is provided, including: a passed data determining module 1702, a tag storage location determining module 1704, and a record generating module 1706.

The passed data determining module 1702 is configured to: determine, in a running process of an application, a machine executable instruction currently being executed for the application; and determine a current execution function executed based on the machine executable instruction, and determine, when the current execution function is of a preset candidate function type for detection, passed data passed to the current execution function.

The tag storage location determining module 1704 is configured to determine a tag storage location of the passed data; in a process of executing a series of execution functions based on original data of the application, a tag storage location of data generated based on any execution function being configured for recording a data source tag of data passed to the any execution function.

The determining module 1706 is configured to determine, when a data source tag is obtained from the tag storage location, that the application undergoes a hot update, the obtained data source tag being configured for indicating that the passed data originates locally or from a network other than an original installation package.

In the foregoing embodiments, a machine executable instruction currently being executed is determined in a running process of the application, a current execution function may be determined based on the machine executable instruction currently being executed, and a function type of the current execution function may be determined by determining the current execution function. When it is determined that the current execution function is of a preset candidate function type for detection, it is determined that a hot update behavior may occur at this moment, and passed data passed to the current execution function is obtained. When the passed data originates locally or from a network other than an original installation package, it is determined that the application undergoes the hot update, thereby achieving automatic hot update detection in the running process of the application. In a process of executing a series of execution functions based on original data of the application, a tag storage location of data generated based on any execution function may record a data source tag of data passed to the any execution function, so that after the passed data passed to the current execution function is obtained, a tag storage location of the passed data may be further determined. When a data source tag is obtained from the tag storage location of the passed data, it is determined that the application undergoes the hot update, and the obtained data source tag is configured for indicating that the passed data originates locally or from the network other than the original installation package. Therefore, in the solution of the present disclosure, a source of data passing is determined, and with reference to a precise function type and a data tagging mechanism, an algorithm can efficiently and accurately identify whether a hot update occurs. In comparison with a typical hot update detection method by manually analyzing an installation package file, the present disclosure improves efficiency of hot update detection.

In an embodiment, the application runs on the virtual terminal, and the application is obtained by triggering, based on a preset installation instruction after an installation package of the application is uploaded to the detection platform via an installation package upload page, the virtual terminal to install the installation package.

In an embodiment, when the passed data is generated based on the original data, the data source tag of the original data is recorded at the tag storage location of the passed data. The hot update detection apparatus 1700 further includes a tag generating module, configured to: determine, when the original data is obtained from the network, that the data source tag of the original data is a first tag configured for indicating a network source; and determine, when the original data is obtained locally, that the data source tag of the original data is a second tag configured for indicating a local source.

In an embodiment, the tag generating module is further configured to: obtain a preset first function set, the first function set including a system call function that is supported by the application and that is configured for receiving network data; determine a data obtaining function configured for obtaining the original data; match the data obtaining function with the system call function in the first function set; and determine, when the data obtaining function successfully matches the system call function in the first function set, that the original data is obtained from the network, and use the first tag as the data source tag of the original data.

In an embodiment, the tag generating module is further configured to: obtain a preset second function set, the second function set including a system call function that is supported by the application and that is configured for file reading/writing; match the data obtaining function with the system call function in the second function set; and determine, when the data obtaining function successfully matches the system call function in the second function set, that the original data is obtained locally, and use the second tag as the data source tag of the original data.

In an embodiment, the tag storage location determining module 1704 is further configured to: determine, when the passed data is of a data object type, that the tag storage location of the passed data is an extended structure of the passed data; and determine, when the passed data is of a non-data object type, that the tag storage location of the passed data is a virtual machine stack storing the passed data.

In an embodiment, the hot update detection apparatus 1700 further includes a tag passing module, configured to use, in a process of passing the passed data to a next execution function based on the current execution function, the data source tag of the passed data as metadata of the passed data, and pass the metadata to the next execution function.

In an embodiment, the tag passing module is further configured to: determine, when the passed data is processed based on the next execution function to obtain processed data, and the processed data is stored in the virtual machine stack, a storage location of the processed data in the virtual machine stack; determine a tag storage location of the processed data based on the storage location of the processed data in the virtual machine stack; and store the data source tag of the passed data at the tag storage location of the processed data.

In an embodiment, the tag passing module is further configured to: add, when the passed data is processed based on the next execution function to obtain processed data, and the processed data is a data object, a member variable to an extended structure of the processed data; and use the data source tag extracted from the tag storage location of the passed data as a value of the added member variable.

In an embodiment, the application runs on the virtual terminal; when the virtual machine in the virtual terminal runs in an interpretation execution mode, in the running process of the application, a data source tag passing instruction configured for passing a data source tag is inserted each time after execution of an original machine executable instruction, the original machine executable instruction being a machine executable instruction generated based on the installation package of the application; and when the virtual machine in the virtual terminal runs in a compilation execution mode, in a process of compiling the application by using a compiler of the virtual machine, the data source tag passing instruction configured for passing the data source tag is inserted.

In an embodiment, the hot update detection apparatus 1700 further includes the record generating module, configured to: generate a hot update record based on the passed data and the data source tag obtained from the tag storage location of the passed data; and transmit the hot update record to the detection platform.

In an embodiment, the record generating module is further configured to: determine, when a tag set is extracted from the tag storage location of the passed data, a data source of the passed data based on a tag in the tag set; determine the data source of the passed data based on the tag in the tag set; generate the hot update record based on the data source of the passed data, the passed data, and the tag in the tag set; and transmit the hot update record to the detection platform.

In an embodiment, the record generating module is further configured to: determine, when the tag set includes the first tag configured for indicating the network source, that the data source of the passed data is the network; and determine, when the tag set includes only the second tag configured for indicating the local source, that the data source of the passed data is local.

In an embodiment, the record generating module is further configured to: obtain, when determining that the data source of the passed data is the network, a network request that is transmitted by the application in the running process and that is related to the passed data; determine a network link carried in the network request, and match the network link with a preset official application update link, to obtain a matching result; and when determining, based on the matching result, that the application does not undergo the hot update through an official update channel, generate the hot update record based on the matching result, the data source, the passed data, and the tag in the tag set.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. For example, all or a part of the modules in the foregoing hot update detection apparatus may be implemented by using software, hardware, or a combination thereof. The foregoing modules may be built in or independent of a processor of a computer device in a form of hardware, or may be stored in a memory of the computer device in a form of software, for the processor to invoke to perform operations corresponding to the foregoing modules.

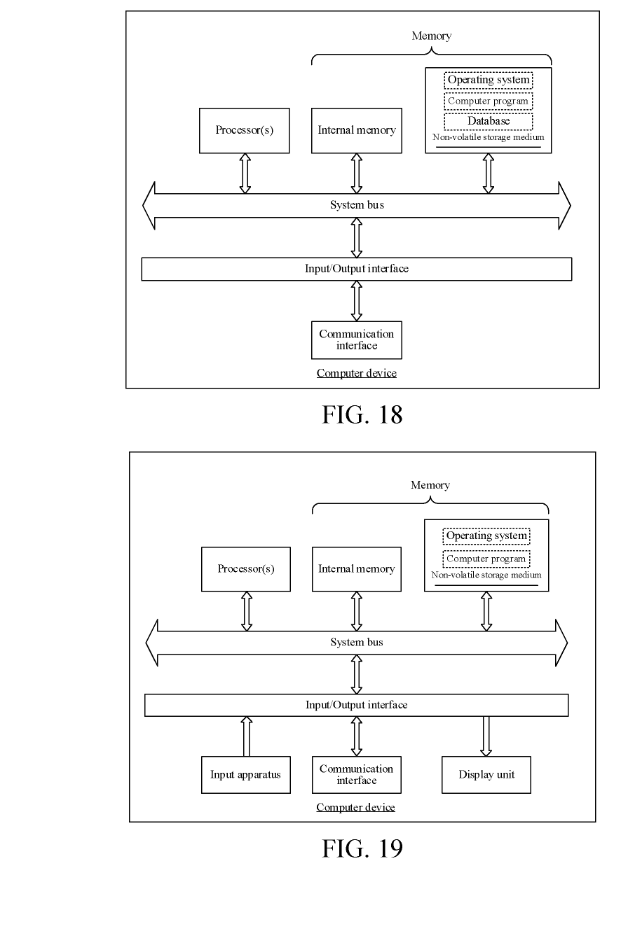

In an embodiment, a computer device is provided. The computer device may be a server, and an internal structure diagram of the computer device may be shown in FIG. 18. The computer device includes a processor, a memory, an input/output (I/O) interface, and a communication interface. The processor, the memory, and the input/output interface are connected via a system bus, and the communication interface is connected to the system bus via the input/output interface. The processor of the computer device is configured to provide computing and control capabilities. The memory of the computer device includes a non-volatile storage medium and an internal memory. The non-volatile storage medium has an operating system, computer-readable instructions, and a database stored therein. The internal memory provides an environment for operation of the operating system and the computer-readable instructions in the non-volatile storage medium. The database of the computer device is configured to store hot update detection data. The input/output interface of the computer device is configured for information exchange between the processor and an external device. The communication interface of the computer device is configured to communicate with an external terminal via a network. The computer-readable instructions, when executed by the processor, implement a hot update detection method.

In an embodiment, a computer device is provided. The computer device may be a terminal, and a diagram of an internal structure of the computer device may be shown in FIG. 19. The computer device includes a processor, a memory, an input/output interface, a communication interface, a display unit, and an input apparatus. The processor, the memory, and the input/output interface are connected via a system bus, and the communication interface, the display unit, and the input apparatus are connected to the system bus via the input/output interface. The processor of the computer device is configured to provide computing and control capabilities. The memory of the computer device includes a non-volatile storage medium and an internal memory. The non-volatile storage medium has an operating system and computer-readable instructions stored therein. The internal memory provides an environment for operation of the operating system and the computer-readable instructions in the non-volatile storage medium. The input/output interface of the computer device is configured for information exchange between the processor and an external device. The communication interface of the computer device is configured for wired or wireless communication with an external terminal. The wireless communication may be implemented through WIFI, a mobile cellular network, near-field communication (NFC), or another technology. The computer-readable instructions, when executed by the processor, implement a hot update detection method. The display unit of the computer device is configured to form a visual picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, a touchpad, a mouse, or the like.

A person skilled in the art may understand that, the structures shown in FIGS. 18 and 19 are merely block diagrams of a part of structures related to a solution of the present disclosure and does not limit the computer device to which the solution of the present disclosure is applied. Specifically, the computer device may include more or fewer components than those in the drawings, or some components may be combined, or a different component layout may be used.

In an embodiment, a computer device is further provided, including a memory and a processor. The memory has computer-readable instructions stored therein. The processor, when executing the computer-readable instructions, implements the operations in the foregoing method embodiments.

In an embodiment, a computer-readable storage medium is provided, having computer-readable instructions stored therein. When the computer-readable instructions are executed by a processor, the operations in the foregoing method embodiments are implemented.

In an embodiment, a computer program product or a computer program is provided. The computer program product or the computer program includes computer instructions, and the computer instructions are stored in a computer-readable storage medium. The processor of the computer device reads the computer instructions from the computer-readable storage medium, and the processor executes the computer instructions, to cause the computer device to perform the steps in the method embodiments.

User information (including but not limited to user equipment information, user personal information, and the like) and data (including but not limited to data configured for analysis, stored data, displayed data, and the like) involved in the present disclosure are all information and data authorized by the user or fully authorized by all parties, and collection, use, and processing of relevant data need to comply with relevant laws, regulations, and standards of relevant countries and regions.

A person of ordinary skill in the art may understand that all or a part of procedures of the method in the foregoing embodiments may be implemented by instructing relevant hardware by using computer-readable instructions. The computer-readable instructions may be stored in a non-volatile computer-readable storage medium. When the computer-readable instructions are executed, the procedures of the method embodiments may be implemented. References to the memory, the database, or another medium used in the embodiments provided in the present disclosure may all include at least one of a non-volatile or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a grapheme memory, and the like. The volatile memory may include a random access memory (RAM) and an external cache. As an illustration rather than a limitation, the RAM is available in various forms, such as a static random access memory (SRAM) and a dynamic random access memory (DRAM). The database in the embodiments of the present disclosure may include at least one of a relational database and a non-relational database. The non-relational database may include a blockchain-based distributed database and the like, which is not limited thereto. The processor in the embodiments of the present disclosure may be, but is not limited to, a general-purpose processor, a central processing unit, a graphics processing unit, a digital signal processor, a programmable logic device, a quantum computing-based data processing logic device, or the like.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments merely show several implementations of the present disclosure. Descriptions of embodiments are specific and detailed, but not to be construed as a limitation to the patent scope of the present disclosure. For a person of ordinary skill in the art, several transformations and improvements may be made without departing from the idea of the present disclosure. These transformations and improvements fall within the protection scope of the present disclosure. Therefore, the protection scope of the present disclosure shall be subject to the appended claims.

What is claimed is:

1. A hot update detection method, performed by a computer device, and the method comprising:
determining, in a running process of an application, a machine executable instruction currently being executed for the application;
determining a current execution function executed based on the machine executable instruction, and determining, when the current execution function is of a preset candidate function type for detection, data passed to the current execution function;
determining a tag storage location of the passed data, in a process of executing a series of execution functions based on original data of the application, a tag storage location of data generated based on any execution function being configured for recording a data source tag for data passed to the any execution function; and
determining, when a data source tag is obtained from the tag storage location of the passed data, that the application undergoes a hot update, the obtained data source tag being configured for indicating that the passed data originates locally or from a network other than an original installation package.

2. The method according to claim 1, wherein the application runs on a virtual terminal, and the application is obtained by triggering, based on a preset installation instruction after an installation package of the application is uploaded to a detection platform via an installation package upload page, the virtual terminal to install the installation package.

3. The method according to claim 1, wherein a data source tag of the original data is recorded at the tag storage location of the passed data when the passed data is generated based on the original data, and an operation of generating the data source tag of the original data comprises:
determining, when the original data is obtained from the network, that the data source tag of the original data is a first tag configured for indicating a network source; and
determining, when the original data is obtained locally, that the data source tag of the original data is a second tag configured for indicating a local source.

4. The method according to claim 3, wherein determining, when the original data is obtained from the network, that the data source tag of the original data is the first tag configured for indicating the network source comprises:
obtaining a preset first function set, the first function set comprising a system call function that is supported by the application and that is configured for receiving network data;
determining a data obtaining function configured for obtaining the original data;
matching the data obtaining function with the system call function in the first function set; and
determining, when the data obtaining function successfully matches the system call function in the first function set, that the original data is obtained from the network, and using the first tag as the data source tag of the original data.

5. The method according to claim 3, wherein determining, when the original data is obtained locally, that the data source tag of the original data is the second tag configured for indicating the local source comprises:
obtaining a preset second function set, the second function set comprising a system call function that is supported by the application and that is configured for file reading/writing;
matching the data obtaining function with the system call function in the second function set; and
determining, when the data obtaining function successfully matches the system call function in the second function set, that the original data is obtained locally, and using the second tag as the data source tag of the original data.

6. The method according to claim 1, wherein determining the tag storage location of the passed data comprises:
determining, when the passed data is of a data object type, that the tag storage location of the passed data is an extended structure of the passed data; and
determining, when the passed data is of a non-data object type, that the tag storage location of the passed data is a virtual machine stack storing the passed data.

7. The method according to claim 1, further comprising:
generating, in a process of passing the passed data to a next execution function based on the current execution function, metadata of the passed data based on the data source tag extracted from the tag storage location of the passed data; and
passing the passed data together with the metadata of the passed data to the next execution function.

8. The method according to claim 7, further comprising:
determining, when the passed data is processed based on the next execution function to obtain processed data, and the processed data is stored in a virtual machine stack, a storage location of the processed data in the virtual machine stack;
determining a tag storage location of the processed data based on the storage location of the processed data in the virtual machine stack; and
determining the data source tag extracted from the tag storage location of the passed data based on the metadata of the passed data, and storing the data source tag extracted from the tag storage location of the passed data at the tag storage location of the processed data.

9. The method according to claim 7, further comprising:
adding, when the passed data is processed based on the next execution function to obtain processed data, and the processed data is a data object, a member variable to an extended structure of the processed data; and
determining, based on the metadata of the passed data, the data source tag extracted from the tag storage location of the passed data, and using the data source tag extracted from the tag storage location of the passed data as a value of the added member variable.

10. The method according to claim 1, wherein the application runs on a virtual terminal; and when a virtual machine in the virtual terminal runs in an interpretation execution mode, in the running process of the application, a data source tag passing instruction configured for passing a data source tag is inserted each time after execution of an original machine executable instruction, the original machine executable instruction being a machine executable instruction generated based on an installation package of the application; and
when the virtual machine in the virtual terminal runs in a compilation execution mode, in a process of compiling the application by using a compiler of the virtual machine, the data source tag passing instruction configured for passing the data source tag is inserted.

11. The method according to claim 1, further comprising:
generating a hot update record based on the passed data and the data source tag obtained from the tag storage location of the passed data; and
transmitting the hot update record to the detection platform.

12. The method according to claim 11, wherein generating the hot update record based on the passed data and the data source tag obtained from the tag storage location of the passed data comprises:
determining, when a tag set is extracted from the tag storage location of the passed data, a data source of the passed data based on a data source tag in the tag set;
determining the data source of the passed data based on the data source tag in the tag set; and
generating the hot update record based on the data source of the passed data, the passed data, and the data source tag in the tag set.

13. The method according to claim 12, wherein the data source tag comprises the first tag and the second tag, the first tag being configured for indicating the network source, and the second tag being configured for indicating the local source; and determining the data source of the passed data based on the data source tag in the tag set comprises:
determining, when the tag set comprises the first tag, that the data source of the passed data is the network; or
determining, when the tag set comprises the second tag, that the data source of the passed data is local.

14. The method according to claim, wherein generating the hot update record based on the data source of the passed data, the passed data, and the data source tag in the tag set comprises:
obtaining, when determining that the data source of the passed data is the network, a network request that is transmitted by the application in the running process and that is related to the passed data;
determining a network link carried in the network request, and matching the network link with a preset official application update link, to obtain a matching result; and
generating, when determining, based on the matching result, that the application does not undergo the hot update through an official update channel, the hot update record based on the matching result, the data source, the passed data, and the data source tag in the tag set.

15. A computer device comprising one or more processors and a memory containing computer readable instructions that, when being executed, cause the one or more processors to perform:
determining, in a running process of an application, a machine executable instruction currently being executed for the application;
determining a current execution function executed based on the machine executable instruction, and determining, when the current execution function is of a preset candidate function type for detection, data passed to the current execution function;
determining a tag storage location of the passed data, in a process of executing a series of execution functions based on original data of the application, a tag storage location of data generated based on any execution function being configured for recording a data source tag for data passed to the any execution function; and
determining, when a data source tag is obtained from the tag storage location of the passed data, that the application undergoes a hot update, the obtained data source tag being configured for indicating that the passed data originates locally or from a network other than an original installation package.

16. The device according to claim 15, wherein the application runs on a virtual terminal, and the application is obtained by triggering, based on a preset installation instruction after an installation package of the application is uploaded to a detection platform via an installation package upload page, the virtual terminal to install the installation package.

17. The device according to claim 15, wherein a data source tag of the original data is recorded at the tag storage location of the passed data when the passed data is generated based on the original data, and the one or more processors are further configured to perform:
determining, when the original data is obtained from the network, that the data source tag of the original data is a first tag configured for indicating a network source; and
determining, when the original data is obtained locally, that the data source tag of the original data is a second tag configured for indicating a local source.

18. The device according to claim 17, wherein the one or more processors are further configured to perform:
obtaining a preset first function set, the first function set comprising a system call function that is supported by the application and that is configured for receiving network data;
determining a data obtaining function configured for obtaining the original data;
matching the data obtaining function with the system call function in the first function set; and
determining, when the data obtaining function successfully matches the system call function in the first function set, that the original data is obtained from the network, and using the first tag as the data source tag of the original data.

19. The device according to claim 17, wherein the one or more processors are further configured to perform:
obtaining a preset second function set, the second function set comprising a system call function that is supported by the application and that is configured for file reading/writing;
matching the data obtaining function with the system call function in the second function set; and
determining, when the data obtaining function successfully matches the system call function in the second function set, that the original data is obtained locally, and using the second tag as the data source tag of the original data.

20. A non-transitory computer readable storage medium containing computer readable instructions that, when being executed, cause at least one processor to perform:
determining, in a running process of an application, a machine executable instruction currently being executed for the application;
determining a current execution function executed based on the machine executable instruction, and determining, when the current execution function is of a preset candidate function type for detection, data passed to the current execution function;
determining a tag storage location of the passed data, in a process of executing a series of execution functions based on original data of the application, a tag storage location of data generated based on any execution function being configured for recording a data source tag for data passed to the any execution function; and
determining, when a data source tag is obtained from the tag storage location of the passed data, that the application undergoes a hot update, the obtained data source tag being configured for indicating that the passed data originates locally or from a network other than an original installation package.
